(19) United States
(12) Patent Application Publication
(10) Pub. No.: US 2026/0291700 A1
(43) Pub. Date: Sep. 24, 2026

(54) TECHNIQUES FOR FULLY-NONCOHERENT FREQUENCY-DOMAIN DETECTORS

(71) Applicant: QUALCOMM Incorporated, San Diego, CA (US)

(72) Inventors: Yavuz YAPICI, Florham Park, NJ (US); Juergen CEZANNE, Ocean Township, NJ (US); Junyi LI, Greentown, PA (US)

(21) Appl. No.: 19/083,214

(22) Filed: Mar. 18, 2025

(51) Int. Cl. H04L 5/00; H04W 72/0453

(52) U.S. Cl. CPC H04L 5/0098; H04W 72/0453

(57) ABSTRACT

Methods, systems, and devices for wireless communications are described. A receiver (Rx) device may receive a backscattered signal from a backscatter-capable device via a backscatter channel, where the backscattered signal is based on an emitter signal that is encoded with a data payload by the backscatter-capable device. The backscattered signal may be associated with a subcarrier allocation configuration that includes a set of occupied subcarriers interleaved with a set of unoccupied subcarriers. The Rx device may determine a modulation phase of the backscattered signal based on a comparison between multiple subcarriers of the backscattered signal that are determined relative to at least one occupied subcarrier based on the subcarrier allocation configuration. The Rx device may then determine a phase shift of the backscattered signal based on the modulation phase, and may decode the data payload from the backscattered signal based on the phase shift.

### FIELD OF TECHNOLOGY

The following relates to wireless communications, including techniques for fully-noncoherent frequency-domain detectors.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method by a receiver (Rx) device is described. The method may include receiving, over a backscatter channel, one or more synchronization signals from a transmitter (Tx) device via a backscatter-capable device, where the one or more synchronization signals are associated with a subcarrier allocation configuration including a set of occupied subcarriers interleaved with a set of unoccupied subcarriers, receiving a backscattered signal from the backscatter-capable device via the backscatter channel, the backscattered signal based on an emitter signal from the Tx device and a data payload from the backscatter-capable device, determining a modulation phase of the backscattered signal based on a comparison between at least a first subcarrier and a second subcarrier of the backscattered signal, where the first subcarrier and the second subcarrier are determined relative to at least one occupied subcarrier of the set of occupied subcarriers based on the subcarrier allocation configuration, and decoding the data payload from the backscattered signal based on a phase shift of the backscattered signal, where the phase shift is determined based on the modulation phase.

An Rx device is described. The Rx device may include one or more memories storing processor executable code, and one or more processors coupled with the one or more memories. The one or more processors may individually or collectively be operable to execute the code to cause the Rx device to receive, over a backscatter channel, one or more synchronization signals from a Tx device via a backscatter-capable device, where the one or more synchronization signals are associated with a subcarrier allocation configuration including a set of occupied subcarriers interleaved with a set of unoccupied subcarriers, receive a backscattered signal from the backscatter-capable device via the backscatter channel, the backscattered signal based on an emitter signal from the Tx device and a data payload from the backscatter-capable device, determine a modulation phase of the backscattered signal based on a comparison between at least a first subcarrier and a second subcarrier of the backscattered signal, where the first subcarrier and the second subcarrier are determined relative to at least one occupied subcarrier of the set of occupied subcarriers based on the subcarrier allocation configuration, and decode the data payload from the backscattered signal based on a phase shift of the backscattered signal, where the phase shift is determined based on the modulation phase.

Another Rx device is described. The Rx device may include means for receiving, over a backscatter channel, one or more synchronization signals from a Tx device via a backscatter-capable device, where the one or more synchronization signals are associated with a subcarrier allocation configuration including a set of occupied subcarriers interleaved with a set of unoccupied subcarriers, means for receiving a backscattered signal from the backscatter-capable device via the backscatter channel, the backscattered signal based on an emitter signal from the Tx device and a data payload from the backscatter-capable device, means for determining a modulation phase of the backscattered signal based on a comparison between at least a first subcarrier and a second subcarrier of the backscattered signal, where the first subcarrier and the second subcarrier are determined relative to at least one occupied subcarrier of the set of occupied subcarriers based on the subcarrier allocation configuration, and means for decoding the data payload from the backscattered signal based on a phase shift of the backscattered signal, where the phase shift is determined based on the modulation phase.

A non-transitory computer-readable medium storing code is described. The code may include instructions executable by one or more processors to receive, over a backscatter channel, one or more synchronization signals from a Tx device via a backscatter-capable device, where the one or more synchronization signals are associated with a subcarrier allocation configuration including a set of occupied subcarriers interleaved with a set of unoccupied subcarriers, receive a backscattered signal from the backscatter-capable device via the backscatter channel, the backscattered signal based on an emitter signal from the Tx device and a data payload from the backscatter-capable device, determine a modulation phase of the backscattered signal based on a comparison between at least a first subcarrier and a second subcarrier of the backscattered signal, where the first subcarrier and the second subcarrier are determined relative to at least one occupied subcarrier of the set of occupied subcarriers based on the subcarrier allocation configuration, and decode the data payload from the backscattered signal based on a phase shift of the backscattered signal, where the phase shift is determined based on the modulation phase.

In some examples of the method, Rx devices, and non-transitory computer-readable medium described herein, the modulation phase may be further determined based on channel flatness information of the backscatter channel across at least the first subcarrier and the second subcarrier, the channel flatness information associated with characteristics of the backscatter channel across a frequency domain.

Some examples of the method, Rx devices, and non-transitory computer-readable medium described herein may further include operations, features, means, or instructions for transmitting, to the Tx device, a request for the channel flatness information and receiving the channel flatness information from the Tx device in response to the request.

Some examples of the method, Rx devices, and non-transitory computer-readable medium described herein may further include operations, features, means, or instructions for determining that one or more characteristics of the first subcarrier may be the same or similar to one or more additional characteristics of the second subcarrier based on the channel flatness information, where the modulation phase may be determined based on the one or more characteristics of the first subcarrier being the same or similar to the one or more additional characteristics of the second subcarrier.

In some examples of the method, Rx devices, and non-transitory computer-readable medium described herein, the modulation phase may be further determined based on a channel autocorrelation metric associated with the backscatter channel.

Some examples of the method, Rx devices, and non-transitory computer-readable medium described herein may further include operations, features, means, or instructions for transmitting, to the Tx device, a request for the channel autocorrelation metric and receiving the channel autocorrelation metric from the Tx device in response to the request.

In some examples of the method, Rx devices, and non-transitory computer-readable medium described herein, the modulation phase may be further determined based on the emitter signal including a constant-energy signal.

In some examples of the method, Rx devices, and non-transitory computer-readable medium described herein, the emitter signal may be transmitted from the Tx device to the backscatter-capable device via a forward channel and the subcarrier allocation configuration may be based on channel flatness information of the backscatter channel, the forward channel, or both, across at least the first subcarrier and the second subcarrier, the channel flatness information associated with characteristics of the backscatter channel across a frequency domain.

In some examples of the method, Rx devices, and non-transitory computer-readable medium described herein, the first subcarrier and the second subcarrier may be determined based on a comparison between first channel flatness information of the forward channel and second channel flatness information of the backscatter channel.

In some examples of the method, Rx devices, and non-transitory computer-readable medium described herein, the first subcarrier and the second subcarrier may be determined based on a first distance between the Tx device and the backscatter-capable device, a second distance between the backscatter-capable device and the Rx device, or both.

In some examples of the method, Rx devices, and non-transitory computer-readable medium described herein, the subcarrier allocation configuration may be based on an energy consumption constraint associated with the Tx device, the Rx device, or both.

In some examples of the method, Rx devices, and non-transitory computer-readable medium described herein, the Tx device and the Rx device include a single wireless communication device.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports techniques for fully-noncoherent frequency-domain detectors in accordance with one or more aspects of the present disclosure.

FIG. 2 shows an example of a wireless communications system that supports techniques for fully-noncoherent frequency-domain detectors in accordance with one or more aspects of the present disclosure.

FIG. 3 shows an example of a signaling diagram that supports techniques for fully-noncoherent frequency-domain detectors in accordance with one or more aspects of the present disclosure.

FIG. 4 shows an example of a signaling diagram that supports techniques for fully-noncoherent frequency-domain detectors in accordance with one or more aspects of the present disclosure.

FIG. 5 shows an example of a signaling diagram that supports techniques for fully-noncoherent frequency-domain detectors in accordance with one or more aspects of the present disclosure.

FIG. 6 shows an example of a process flow that supports techniques for fully-noncoherent frequency-domain detectors in accordance with one or more aspects of the present disclosure.

FIGS. 7 and 8 show block diagrams of devices that support techniques for fully-noncoherent frequency-domain detectors in accordance with one or more aspects of the present disclosure.

FIG. 9 shows a block diagram of a communications manager that supports techniques for fully-noncoherent frequency-domain detectors in accordance with one or more aspects of the present disclosure.

FIG. 10 shows a diagram of a system including a device that supports techniques for fully-noncoherent frequency-domain detectors in accordance with one or more aspects of the present disclosure.

FIG. 11 shows a flowchart illustrating methods that support techniques for fully-noncoherent frequency-domain detectors in accordance with one or more aspects of the present disclosure.

### DETAILED DESCRIPTION

Some wireless systems may include passive or mostly passive devices, such as ambient IoT (A-IoT) tags or reconfigurable intelligent surfaces (RISs), that are configured to reflect/backscatter a signal received from a transmitter (Tx) device to a reader/receiver (Rx) device. Such passive, reflective devices may be configured to encode small amounts of information in the backscattered signals, known as reflection modulation, which may be implemented by shifting the backscattered signals in the time domain. There are two main demodulation techniques that may be used by the Rx device to decode the backscattered signals: time-domain demodulation and frequency-domain demodulation.

In the context of time-domain demodulation, the backscattered signal received at the Rx device is correlated with an internal clock to determine the time shift and decode the data. However, time-domain demodulation becomes challenging when the pattern of reflection modulation (after reflection/relay by the reflective device) is complex, which may be the case to improve signal reliability, avoid interference, and improve energy efficiency. Comparatively, for frequency-domain demodulation, the Rx device has to perform channel estimation for the backscatter link between the reflective device and the Rx device, where the channel estimation may be used to estimate the phase and time shift of the backscattered signal. That is, conventional frequency-domain demodulation techniques are “fully coherent” in that they require the Rx device to perform channel estimation. However, performing channel estimation may be difficult in low-power scenarios, which is often the case in the contest of passive, reflective devices.

Accordingly, aspects of the present disclosure are directed to techniques for performing fully non-coherent frequency-domain demodulation at an Rx device. That is, aspects of the present disclosure may enable an Rx device to perform frequency-domain demodulation in order to decode received backscattered signals without requiring the Rx device to perform channel estimation. For example, a Tx device may transmit signals with a defined subcarrier allocation configuration that includes occupied subcarriers interleaved with unoccupied subcarriers (where the ratio of occupied-to-unoccupied subcarriers may be referred to as an “occupancy ratio”). The signals may be reflected by a reflective device (e.g., RFID tag, A-IoT device, RIS) to an Rx device as backscattered signals, where the subcarrier allocation configuration may be known by the Rx device. To decode data encoded into the backscattered signals, the Rx device may determine a modulation phase of the backscattered signals by comparing unoccupied subcarriers of the backscattered signals to occupied subcarriers based on the subcarrier allocation configuration. Subsequently, the modulation phase of the backscattered signal may be used to determine the phase shift of the backscattered signal, thereby enabling the Rx device to determine the data payload encoded by the reflective device.

Techniques described herein may enable more efficient frequency-domain demodulation at Rx devices without requiring the Rx devices to perform channel estimation. As such, techniques described herein may enable Rx devices to demodulate backscattered signals with lower processing resources, thereby reducing power consumption and improving battery performance.

Aspects of the disclosure are initially described in the context of wireless communications systems. Additional aspects of the disclosure are further described in the context of example signaling diagrams and an example process flow. Aspects of the disclosure are further illustrated by and described with reference to apparatus diagrams, system diagrams, and flowcharts that relate to techniques for fully-noncoherent frequency-domain detectors.

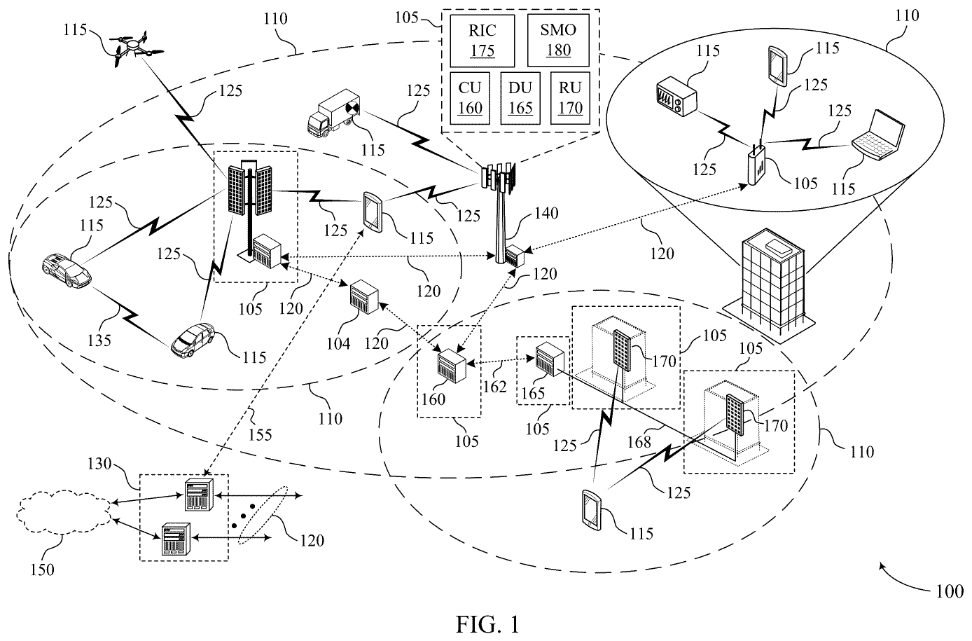

FIG. 1 shows an example of a wireless communications system 100 that supports techniques for fully-noncoherent frequency-domain detectors in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

For instance, an access network (AN) or RAN may include communications between access nodes (e.g., an IAB donor), IAB node(s) 104, and one or more UEs 115. The IAB donor may facilitate connection between the core network 130 and the AN (e.g., via a wired or wireless connection to the core network 130). That is, an IAB donor may refer to a RAN node with a wired or wireless connection to the core network 130. The IAB donor may include one or more of a CU 160, a DU 165, and an RU 170, in which case the CU 160 may communicate with the core network 130 via an interface (e.g., a backhaul link). The IAB donor and IAB node(s) 104 may communicate via an F1 interface according to a protocol that defines signaling messages (e.g., an F1 AP protocol). Additionally, or alternatively, the CU 160 may communicate with the core network 130 via an interface, which may be an example of a portion of a backhaul link, and may communicate with other CUs (e.g., including a CU 160 associated with an alternative IAB donor) via an Xn-C interface, which may be an example of another portion of a backhaul link.

IAB node(s) 104 may refer to RAN nodes that provide IAB functionality (e.g., access for UEs 115, wireless self-backhauling capabilities). A DU 165 may act as a distributed scheduling node towards child nodes associated with the IAB node(s) 104, and the IAB-MT may act as a scheduled node towards parent nodes associated with IAB node(s) 104. That is, an IAB donor may be referred to as a parent node in communication with one or more child nodes (e.g., an IAB donor may relay transmissions for UEs through other IAB node(s) 104). Additionally, or alternatively, IAB node(s) 104 may also be referred to as parent nodes or child nodes to other IAB node(s) 104, depending on the relay chain or configuration of the AN. The IAB-MT entity of IAB node(s) 104 may provide a Uu interface for a child IAB node (e.g., the IAB node(s) 104) to receive signaling from a parent IAB node (e.g., the IAB node(s) 104), and a DU interface (e.g., a DU 165) may provide a Uu interface for a parent IAB node to signal to a child IAB node or UE 115.

For example, IAB node(s) 104 may be referred to as parent nodes that support communications for child IAB nodes, or may be referred to as child IAB nodes associated with IAB donors, or both. An IAB donor may include a CU 160 with a wired or wireless connection (e.g., backhaul communication link(s) 120) to the core network 130 and may act as a parent node to IAB node(s) 104. For example, the DU 165 of an IAB donor may relay transmissions to UEs 115 through IAB node(s) 104, or may directly signal transmissions to a UE 115, or both. The CU 160 of the IAB donor may signal communication link establishment via an F1 interface to IAB node(s) 104, and the IAB node(s) 104 may schedule transmissions (e.g., transmissions to the UEs 115 relayed from the IAB donor) through one or more DUs (e.g., DUs 165). That is, data may be relayed to and from IAB node(s) 104 via signaling via an NR Uu interface to MT of IAB node(s) 104 (e.g., other IAB node(s)). Communications with IAB node(s) 104 may be scheduled by a DU 165 of the IAB donor or of IAB node(s) 104.

In the case of the techniques described herein applied in the context of a disaggregated RAN architecture, one or more components of the disaggregated RAN architecture may be configured to support techniques for fully-noncoherent frequency-domain detectors as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

In some examples, such as in a carrier aggregation configuration, a carrier may have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different RAT).

The communication link(s) 125 of the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular RAT (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may support synchronous or asynchronous operation. For synchronous operation, network entities 105 (e.g., base stations 140) may have similar frame timings, and transmissions from different network entities (e.g., different ones of the network entities 105) may be approximately aligned in time. For asynchronous operation, network entities 105 may have different frame timings, and transmissions from different network entities (e.g., different ones of network entities 105) may, in some examples, not be aligned in time. The techniques described herein may be used for either synchronous or asynchronous operations.

Some UEs 115, such as MTC or IoT devices, may be relatively low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 may include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by a transmitting device (e.g., a network entity 105 or a UE 115) along a single beam direction (e.g., a direction associated with the receiving device, such as another network entity 105 or UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., the communication link(s) 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in relatively poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

In some implementations, the wireless communications system 100 may include backscatter-capable devices, such as RFID tags, A-IoT devices, and RISs. Such backscatter-capable devices may be configured to receive signals from a Tx device via a forward channel, encode data within the received signals, and reflect or otherwise relay the received signals as backscattered signals (with the encoded data) to an Rx device via a backscatter channel.

In some aspects, the respective wireless devices of the wireless communications system 100 may support techniques for performing fully non-coherent frequency-domain demodulation at an Rx device. That is, aspects of the present disclosure may enable an Rx device to perform frequency-domain demodulation in order to decode received backscattered signals without requiring the Rx device to perform channel estimation, and to enable the Tx device to embed known pilot symbols into the transmitted signal. For example, a Tx device may transmit signals with a defined subcarrier allocation configuration that includes occupied subcarriers interleaved with unoccupied subcarriers (where the ratio of occupied-to-unoccupied subcarriers may be referred to as an “occupancy ratio”). The signals may be reflected by a reflective device (e.g., RFID tag, A-IoT device, RIS) to an Rx device as backscattered signals, where the subcarrier allocation configuration may be known by the Rx device. To decode data encoded into the backscattered signals, the Rx device may determine a modulation phase of the backscattered signals by comparing unoccupied subcarriers of the backscattered signals to occupied subcarriers based on the subcarrier allocation configuration. Subsequently, the modulation phase of the backscattered signal may be used to determine the phase shift of the backscattered signal, thereby enabling the Rx device to determine the data payload encoded by the reflective device.

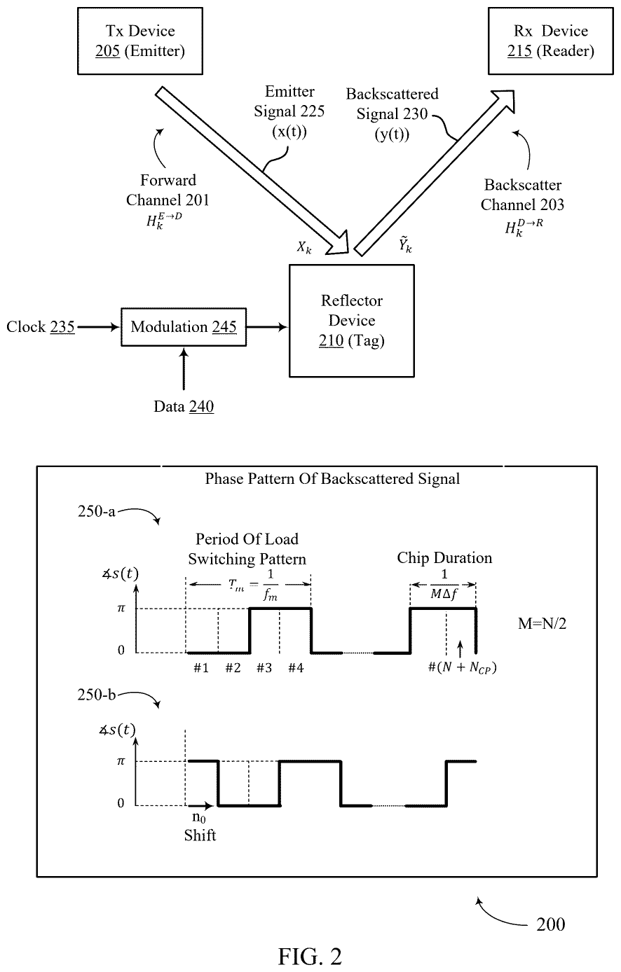

FIG. 2 shows an example of a wireless communications system 200 that supports techniques for fully-noncoherent frequency-domain detectors in accordance with one or more aspects of the present disclosure. Aspects of the wireless communications system 200 may implement, or be implemented by, aspects of the wireless communications system 100.

The wireless communications system 200 may include a Tx device 205 (e.g., emitter device), a reflector device 210, and an Rx device 215 (e.g., reader device). The reflector device 210 may be configured to receive signals (e.g., emitter signals 225, represented as x(t)) from the Tx device 205 via a forward channel 201, encode the emitter signals 225 with data 240, and reflect or otherwise relay the received signals with the encoded data 240 as backscattered signals 230 (represented as y(t)) to the Rx device 215 via a backscatter channel 203. In this regard, the reflector device 210 may also be referred to as a “backscatter-capable device.” For example, the reflector device 210 may include a radio frequency identifier (RFID) tag, an A-IoT device, a reflective intelligent surface (RIS), or any combination thereof.

In some aspects, the Tx device 205 and the Rx device 215 may be different devices, or may be the same device. That is, in some cases, the same device that “queries” the reflector device 210 (e.g., RFID tag) via the emitter signals 225 may be the same device that reads the backscattered signals 230 reflected/transmitted back from the reflector device 210.

In some cases, the reflector device 210 may include a passive (or mostly passive) device that does not include a separate power source. As such, in some cases, the reflector device 210 may use power received from the emitter signal 225 to encode small amounts of data 240. For example, the reflector device 210 may include a small device on a shelf of a supermarket that is “queried” via the emitter signal 225, and which encodes a small amount of data 240 that indicates whether or not a product associated with the reflector device 210 is still in stock or not. By way of another example, the reflector device 210 may include a device associated with a parking meter, where the data 240 indicates whether or not the parking meter has been paid/filled, and/or whether or not there is currently a car parked at the parking meter.

As noted previously herein, reflector devices 210 may be configured to encode small amounts of information (e.g., data 240) within the backscattered signals 230 by shifting the backscattered signals in the time domain, which is known as reflection modulation. Reflection modulation is a key technique for various low-power or battery-less network nodes (e.g., reflector device 210, RISs, A-IoT tags, etc.) that leverage backscattering communication principles. One way to perform reflection modulation is by periodic waveforms, which govern switching patterns of the antenna loads and induce the desired phase shift on the reflected wave through data-dependent time-domain shifts.

For example, the diagrams 250-a, 250-b at the bottom of FIG. 2 illustrate periodic antenna load switching that may be performed by the reflector device 210 to encode data 240 within the backscattered signals 230. In some cases, upon receiving the emitter signal 225 (x(t)), the reflector device 210 may reflect the incident emitter signal 225 (x(t)) using different antenna loads that are switched over time in a periodic fashion according to a reflection coefficient (s(t)). In some aspects, the reflection coefficient s(t) may be associated with a period of

$$\frac{1}{{f}_{m}} .$$

The modulation 245 may be performed by applying a time shift to this periodic pattern based on the bits of the data 240 to be encoded.

That is, the reflector device 210 may use a clock 235 (e.g., original clock, internal clock) to perform modulation 245 in order to encode the incident signal (x(t)) with the data 240, and reflect/relay the backscattered signal 230 (y(t)) via the backscatter channel 203. In this regard, the reflected, backscattered signal 230 may be represented by Equation 1 below:

$$y ( t ) = s ( t ) x ( t ) \qquad ( 1 )$$

where y(t) represents the reflected signal (e.g., backscattered signal 230), x(t) represents the incident signal (e.g., emitter signal 225), and s(t) represents the reflection coefficient used by the reflector device 210.

In applying the reflection coefficient s(t) to the incident signal x(t), the reflector device 210 may effectively “shift” the incident signal in the time domain by a value n₀. The diagrams 250-a, 250-b illustrate reflection phase patterns of the reflected signal (e.g., backscattered signal 230) reflected by the reflector device 210. In particular, the first diagram 250-a illustrates a reflection phase pattern of the backscattered signal 230 when the reflector device does not encode any data (e.g., does not implement a phase shift). Comparatively, the second diagram 250-b illustrates a reflection phase pattern of the backscattered signal 230 when the reflector device encodes data 240 by implementing a phase shift n₀ (e.g., n₀=1). As shown in FIG. 2, there may be four separate phase shift values (e.g., n₀=1, 2, 3, 4) which may represent different bits of data 240/information that may be encoded by the reflector device 210.

The forward channel 201 between the Tx device 205 and the reflector device 210 may be represented by

$${H}_{k}^{E \to D} ,$$

and the backscatter channel 203 between the reflector device 210 and the Rx device 215 may be represented by

$${H}_{k}^{D \to R} .$$

The spectrum of the emitter signal 225 may be represented by Xₖ, and the spectrum of the backscattered signal 230 may be represented by Yₖ, which may be defined according to Equation 2 below:

$${Y}_{k} = {\sum }_{\begin{matrix}ℓ = 1 \\ ℓ : odd\end{matrix}}^{∞} \frac{2}{j πℓ} ( {e}^{- j \frac{π {n}_{0} ℓ M}{N}} {X}_{k - ℓ M / 2} - {e}^{j \frac{π {n}_{0} ℓ M}{N}} {X}_{k + ℓ M / 2} ) \qquad ( 2 )$$

Yₖ represents the spectrum of the backscattered signal 230, Xₖ represents the spectrum of the emitter signal 225, [symbol] indicates the ordered harmonic (e.g., first-order harmonic, second-order harmonic, etc.), no defines the discrete phase shift, k defines the subcarrier index, j defines an imaginary number (i.e. \sqrt{−1}) and M defines the discrete chip rate. Furthermore, the term

$$j \frac{π {n}_{0} ℓ M}{N}$$

(which is bolded in Equation 2 above) indicates the modulation phase of the backscattered signal 230.

In some aspects, the Rx device 215 may be configured to demodulate the backscattered signal 230 in order to decode and retrieve the data 240 encoded by the reflector device 210. Demodulation of the backscattered signal 230 at the Rx device 215 may be performed in either the time domain or the frequency domain. That is, there are two main demodulation techniques that may be used by the Rx device to decode the backscattered signals: (1) time-domain demodulation, and (2) frequency-domain demodulation.

In the context of time-domain demodulation, the backscattered signal 230 received at the Rx device 215 is correlated with an internal clock 235 to determine the time shift (e.g., determine n₀) and decode the data 240. However, time-domain demodulation becomes challenging when the antenna switching/modulation pattern of the emitter signal 225 emitted by the Tx device 205 (and reflected by the reflector device 210) is complex. For example, the diagrams 250 in FIG. 2 illustrate simple antenna switching patterns with only two “levels” (e.g., reflection phases of 0 and π). However, in order to mitigate effects of undesired harmonics, in some cases, the Tx device 205 may use more complex antenna switching patterns with more “levels” (e.g., reflection phases of 0, π, and an intermediate reflection phase of ϵ). These more complex antenna switching patterns may help mitigate effects of undesired harmonics, but may be challenging to decode with time-domain demodulation, particularly with low Tx power signals (as is the case with many passive reflector devices 210). Further, with more complex antenna switching patterns, the Rx device may need to know waveform parameters (e.g., periods between the respective reflection phases), which may lead to increased signaling overhead that is used to communicate the waveform parameters from the reflector device 210 to the Rx device 215.

Comparatively, for frequency-domain demodulation, the Rx device 215 may evaluate the spectrum for frequency-domain demodulation. As such, the Rx device 215 may not need to know waveform parameters (e.g., periods between the respective reflection phases), which may reduce signaling overhead. However, the frequency-domain demodulation techniques involve estimation of forward and backward channels (e.g., estimate

$${H}_{k}^{E \to D}$$

for the forward channel 201 and

$${H}_{k}^{D \to R}$$

for the backscatter channel 203), which may difficult (if not impossible) for very-low-power communications, and may make the overall transmission coherent (i.e., not non-coherent). That is, conventional frequency-domain demodulation techniques are “fully coherent” in that they require the Rx device 215 to perform channel estimation. However, performing channel estimation may be difficult in low-power scenarios, which is often the case in the contest of passive, reflective devices. The shortfalls of frequency-domain demodulation techniques are further shown and described with reference to FIG. 2.

Taken together, existing time-domain demodulation techniques become challenging for multi-level switching waveforms, and existing frequency-domain demodulation techniques are not fully non-coherent, as they require channel estimation (which is difficult or impossible in low-power scenarios).

Accordingly, aspects of the present disclosure are directed to demodulation strategies for reflection modulation which do not require any channel estimation, and hence are fully non-coherent. In particular, aspects of the present disclosure are directed to techniques for performing fully non-coherent frequency-domain demodulation at the Rx device 215. That is, aspects of the present disclosure may enable the Rx device 215 to perform frequency-domain demodulation in order to decode received backscattered signals 230 without requiring the Rx device 215 to perform channel estimation.

For example, referring to FIG. 2, the Rx device 215 may receive, over the backscatter channel 203, one or more synchronization signals from the Tx device 205 that are reflected or otherwise relayed via the reflector device 210 (e.g., backscatter-capable device). In some aspects, the synchronization signals may be exchanged as part of a synchronization procedure between the respective wireless devices.

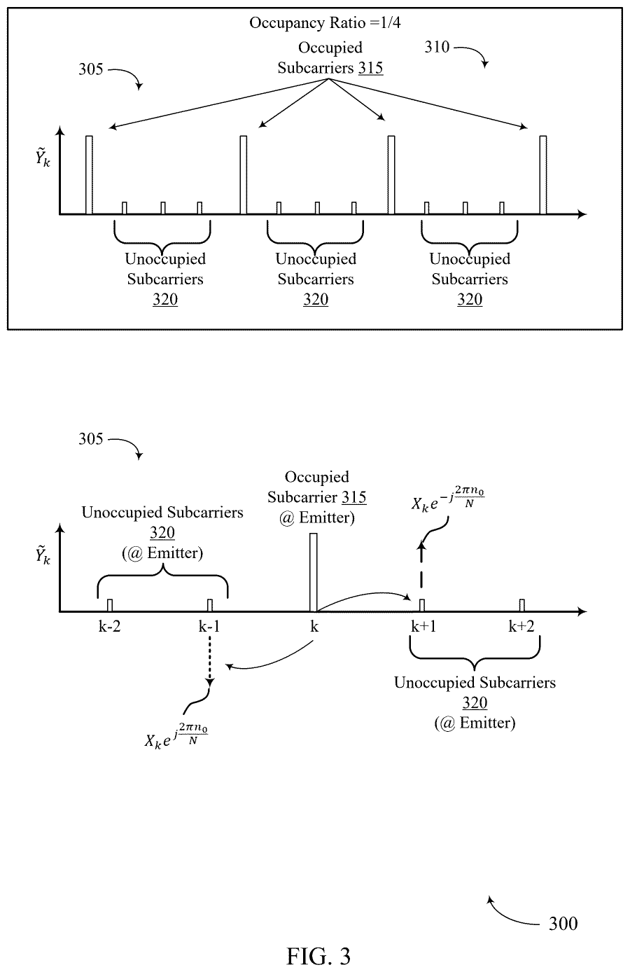

The synchronization signals may be associated with a subcarrier allocation configuration that includes a set of occupied subcarriers interleaved with a set of unoccupied subcarriers, as further shown and described with respect to FIGS. 3-5. In some aspects, the subcarrier allocation configuration may be based on an energy consumption constraint associated with the Tx device 205, the Rx device 215, or both.

At signaling operation 625, the Rx device 215 may transmit, to the Tx device 205, a request for information that will enable the Rx device 215 to decode/demodulate backscattered signals received from the reflector device 210. In some cases, the Rx device 215 may transmit the request based on receiving the synchronization signals. In some aspects, the Rx device 215 may transmit the request to the Tx device 205 directly, and/or via the reflector device 210.

For example, the request may include a request for channel flatness information associated with the forward channel 201 and/or the backscatter channel 203, where the channel flatness information is associated with characteristics of the forward channel 201 and/or the backscatter channel 203 across a frequency domain. That is, channel flatness information may indicate how different frequencies are affected (e.g., in terms of variations in the amplitude, phase, noise, interference, and or other characteristics or measurements of a signal) across the forward channel 201 and/or the backscatter channel 203. For instance, channel flatness information may indicate whether (and/or to what extent) a first frequency is more or less susceptible to interference as compared to a second frequency. By way of another example, the request may include a request for a channel autocorrelation metric associated with the forward channel 201 and/or the backscatter channel 203. In some aspects, the channel flatness information and/or the autocorrelation metric may be usable by the Rx device 215 to decode/demodulate backscattered signals received from the reflector device 210, as will be further shown and described with reference to FIGS. 3-5.

The Rx device 215 may receive information from the Tx device 205 that is usable for decoding/demodulating backscattered signals received from the reflector device 210. For example, the Rx device 215 may receive channel flatness information, a channel autocorrelation metric, or both, in response to transmitting the request.

In some aspects, the Rx device 215 may receive one or more backscattered signals 230 from the reflector device 210. For example, as described previously herein, the Tx device 205 may transmit emitter signals 225 to the reflector device 210 via the forward channel 201. The reflector device 210 may encode the emitter signals 225 with a data payload, and may reflect or otherwise relay the signals to the Rx device 215 (with the encoded data payload) as backscattered signals 230 via the backscatter channel 203. For example, as shown and described with reference to the diagram 250-b, the reflector device 210 may encode the data payload by shifting the emitter signals 225 by a phase shift n₀.

As noted previously herein, the backscattered signal may be transmitted according to the same subcarrier allocation configuration associated with the synchronization signals. That is, the backscattered signals 230 may be associated with the subcarrier allocation configuration (e.g., occupancy ratio) that includes a set of occupied subcarriers that are interleaved with a set of unoccupied subcarriers. Examples of different subcarrier allocation configurations associated with occupancy ratios of 1/4, 1/3, and 1/2, respectively, are further shown and described example with reference to FIGS. 3-5.

In some aspects, the Rx device 215 may determine one or more characteristics across respective subcarriers of the backscattered signal(s) 230. In particular, the Rx device 215 may determine characteristics across the respective subcarriers of the backscattered signals 230 based on receiving the synchronization signals, receiving the channel flatness information and/or autocorrelation metric, or both.

For example, the Rx device 215 may determine that one or more characteristics of a first subcarrier of the backscattered signal(s) 230 are the same (or similar) to one or more additional characteristics of a second subcarrier of the backscattered signal(s) 230 based on the channel flatness information. In other words, the Rx device 215 may determine that the channel characteristics of the forward channel 201 and/or the backscatter channel 203 remain relatively constant in the frequency domain (at least when considering subcarriers that are adjacent or otherwise close to one another in the frequency domain).

The Rx device 215 may determine a modulation phase (e.g., determine

$$j \frac{π {n}_{0} ℓ M}{N}$$

in Equation 2 above) of the backscattered signal(s) 230 based on a comparison between multiple subcarriers of the backscattered signals 230. As used herein, the term “comparison” may be used to refer to one or more mathematical operations using values or characteristics (e.g., amplitude, phase, noise, interference, measurements such as SNR, etc.) of different subcarriers of the backscattered signal(s) 230 in order to determine values or characteristics (e.g., modulation phase) of the backscattered signals 230. That is, the Rx device 215 may be configured to determine the modulation phase without performing channel estimation for the forward channel 201 and/or the backscatter channel 203. The Rx device 215 may determine the modulation phase based on receiving the synchronization signals, receiving the channel information (e.g., channel flatness information, channel autocorrelation metric), receiving the backscattered signals 230, determining the subcarrier characteristic(s) of the backscattered signals 230 (e.g., amplitude, phase, noise, interference, other measurements, etc.), or any combination thereof.

For example, the Rx device 215 may determine a modulation phase (e.g., determine

$$j \frac{π {n}_{0} ℓ M}{N} )$$

of the backscattered signal 230 based on a comparison between a first subcarrier and a second subcarrier of the backscattered signal 230 (e.g., comparison of a first amplitude, first phase, first SNR, etc. of the first subcarrier with a second amplitude, second phase, second SNR, etc. of the second subcarrier). In some cases, the modulation phase may be determined based on the channel flatness information across at least the first subcarrier and the second subcarrier. In this example, the first subcarrier and the second subcarrier may be determined relative to at least one occupied subcarrier of the set of occupied subcarriers based on the subcarrier allocation configuration, as shown and described in FIGS. 3-5.

The Rx device 215 may identify/select the subcarriers of the backscattered signal 230 that are used/compared to determine the modulation phase according to one or more parameters, rules, or characteristics. For example, in some cases, the first and second subcarriers that are compared to determine the modulation phase may be identified/determined based on a comparison between channel flatness information of the forward channel 201 and channel flatness information of the backscatter channel 203. By way of another example, the Rx device 215 may identify/select the first and second subcarriers that are compared to determine the modulation phase based on a first distance between the Tx device 205 and the reflector device 210, a second distance between the reflector device 210 and the Rx device 215, or both.

In additional or alternative implementations, the modulation phase may be determined based on the channel autocorrelation metric, and/or based on the emitter signal transmitted by the Tx device 205 including a constant energy signal.

Subsequently, the Rx device 215 may determine a phase shift (n₀) of the backscattered signal 230. In particular, the Rx device 215 may determine the phase shift (n₀) of the backscattered signal 230 based on the determined modulation phase

$$( j \frac{π {n}_{0} ℓ M}{N} ) ,$$

The Rx device 215 may then decode the data payload from the backscattered signal 230. That is, the Rx device 215 may decode the data payload encoded into the backscattered signal 230 by the reflector device 210. The Rx device 215 may decode the data payload based on the phase shift (n₀), the modulation phase

$$( j \frac{π {n}_{0} ℓ M}{N} ) .$$

or both.

Attendant advantages of the fully-noncoherent frequency-domain demodulation techniques described herein are further shown and described with reference to FIGS. 3-5.

FIG. 3 shows an example of a signaling diagram 300 that supports techniques for fully-noncoherent frequency-domain detectors in accordance with one or more aspects of the present disclosure. Aspects of the signaling diagram 300 may implement, or be implemented by, aspects of the wireless communications system 100, the wireless communications system 200, or both.

The signaling diagram 300 illustrates an example backscattered signal 305, which may be an example of the backscattered signal 230 (and/or synchronization signals) shown and described with respect to FIG. 2. As noted previously herein, the backscattered signal 305 may be transmitted according to a subcarrier allocation configuration 310 (which may be the same subcarrier allocation configuration 310 used for synchronization signals exchanged between the respective devices during a synchronization procedure). That is, the backscattered signals 305 may be associated with the subcarrier allocation configuration 310 (e.g., occupancy ratio) that includes a set of occupied subcarriers 315 (e.g., occupied REs) that are interleaved with a set of unoccupied subcarriers 320 (e.g., unoccupied REs).

For instance, FIG. 3 illustrates an example of a subcarrier allocation configuration 310 with an occupancy ratio of 1/4. In this regard, there is one occupied subcarrier 315 for every four subcarriers (e.g., three unoccupied subcarriers 320 per occupied subcarrier 315). Occupied subcarriers 315 may include subcarriers over which the Tx device 205 transmits energy via the emitter signals 225, where unoccupied subcarriers 320 may include subcarriers over which the Tx device 205 does not transmit any energy (e.g., null or zero-energy subcarriers).

As noted previously herein, conventional frequency-domain demodulation techniques are deficient in that the Rx device 215 may be required to perform channel estimation. That is, conventional frequency-domain demodulation techniques are “fully coherent” in that they require the Rx device 215 to perform channel estimation, which may be difficult (or impossible) to do low-power scenarios, which is often the case in the contest of passive, reflective devices.

For example, with conventional frequency-domain demodulation techniques, the Rx device 215 may be expected to estimate the composite channel using DMRS and known sequence shift (phase shift n₀), which needs a dedicated OFDM symbol with known n₀. With such conventional frequency-domain demodulation techniques, and referring to FIG. 3, the Rx device 215 may identify an occupied subcarrier 315 of the received backscattered signal 305 at subcarrier index k (e.g., RE index k). The received backscattered signal 305 at adjacent unoccupied subcarrier 320 indices k−1 and k+1 may be represented by Equation 3 and Equation 4 below:

$${H}_{k - 1}^{D \to R} ( - \frac{2}{j π} {X}_{k} {e}^{j \frac{2 π {n}_{0}}{N}} ) \qquad ( 3 )$$

$${H}_{k + 1}^{D \to R} ( \frac{2}{j π} {X}_{k} {e}^{- j \frac{2 π {n}_{0}}{N}} ) \qquad ( 4 )$$

where

$${H}_{k - 1}^{D \to R} and {H}_{k + 1}^{D \to R}$$

represent the backscatter channel 203 for the k−1 and k+1 subcarrier, n₀ defines the phase shift, Xₖ represents the emitter signal 225 at subcarrier k, j defines an imaginary number (i.e. \sqrt{−1}), and

$$j \frac{2 π {n}_{0}}{N}$$

represents the modulation phase.

Equations 3 and 4 above may be expanded to form Equations 5 and 6 below, respectively:

$$- \frac{2}{j π} {H}_{k}^{E \to D} {H}_{k - 1}^{D \to R} {X}_{k}^{@ E} {e}^{j \frac{2 π {n}_{0}}{N}} \qquad ( 5 )$$

$$\frac{2}{j π} {H}_{k}^{E \to D} {H}_{k + 1}^{D \to R} {X}_{k}^{@ E} {e}^{- j \frac{2 π {n}_{0}}{N}} \qquad ( 6 )$$

where

$$- \frac{2}{j π} {H}_{k}^{E \to D} {H}_{k - 1}^{D \to R} and \frac{2}{j π} {H}_{k}^{E \to D} {H}_{k + 1}^{D \to R}$$

in Equations 5 and 6, respectively, represent the composite channel between the Tx device 205, the reflector device 210, and the Rx device 215 (e.g., composite channel E→D→R).

Further, the spectrum of the emitter signal 225 may be represented by Xₖ, and the spectrum of the backscattered signal 230 (e.g., backscattered signal 305) may be represented by Yₖ, which may be defined according to Equations 7 and 8 below:

$${\tilde{Y}}_{k} = \frac{2}{j π} ( {e}^{- j \frac{2 π {n}_{0}}{N}} {X}_{k - 1} - {e}^{j \frac{2 π {n}_{0}}{N}} {X}_{k + 1} ) \qquad ( 7 )$$

$${X}_{k} = {H}_{k}^{E \to D} {X}_{k}^{@ E} \qquad ( 8 )$$

Referring to Equations 3-8 above, with conventional frequency-domain demodulation techniques, in order for the Rx device 215 to determine the phase shift n₀, the Rx device 215 may be required to perform channel estimation for the forward channel

$$( {H}_{k}^{E \to D} )$$

and the backscatter channel

$$( {H}_{k - 1}^{D \to R} , {H}_{k + 1}^{D \to R} ) .$$

That is, the overall backscatter transmission is not noncoherent as it involves channel estimation, which may be problematic at low power regime (which is often the case with backscattered communications).

Accordingly, aspects of the present disclosure are directed to fully non-coherent solutions (e.g., fully non-coherent demodulation techniques) which avoid the need for the Rx device 215 to estimate the composite channel. That is, aspects of the present disclosure are directed to demodulation strategies for reflection modulation which do not require any channel estimation, and hence are fully non-coherent.

For example, referring to FIG. 3, the Rx device 215 may receive the backscattered signal 305 that is associated with the subcarrier allocation configuration 310 (e.g., occupancy ratio=1/4). The Rx device 215 may identify an occupied subcarrier 315 at subcarrier index k (e.g., based on the subcarrier allocation configuration). The received backscattered signal 305 at the Rx device 215 at unoccupied subcarrier indices k−1 and k+1 may be represented by Equations 9 and 10 below:

$${H}_{k - 1} ( - \frac{2}{j π} {X}_{k} {e}^{j \frac{2 π {n}_{0}}{N}} ) \qquad ( 9 )$$

$${H}_{k + 1} ( \frac{2}{j π} {X}_{k} {e}^{- j \frac{2 π {n}_{0}}{N}} ) \qquad ( 10 )$$

where Hₖ₋₁ and Hₖ₊₁ represent the backscatter channel 203 for the k−1 and k+1 subcarrier, n₀ defines the phase shift, Xₖ represents the emitter signal 225 at subcarrier k, j defines an imaginary number (i.e. \sqrt{−1}), and

$$j \frac{2 π {n}_{0}}{N}$$

represents the modulation phase.

Taking the product of Equations 9 and 10 above yields Equation 11 below:

$${α}_{k} = {H}_{k - 1}^{*} {H}_{k + 1} \frac{4}{{π}^{2}} {\vert {X}_{k} \vert}^{2} {e}^{- j \frac{2 π {n}_{0}}{N}} \qquad ( 11 )$$

where the phase αₖ is associated with the modulation phase produced by the reflector device 210 (e.g., RFID tag, A-IoT device, RIS).

In some aspects, the Rx device 215 may be able to use the phase αₖ (represented by Equation 11 above) in order to measure/estimate the modulation phase of the backscattered signal 305, and therefore determine the phase shift n₀ of the backscattered signal 305 where the data payload encoded by the reflector device 210 is based on the phase shift n₀).

For example, in some cases, the backscatter channel 203 may not show strong frequency selectivity (e.g., flat channel, which may be indicated by the channel flatness information described herein), so that the phase of the product term approximately represents the tag modulation phase. That is, when the backscatter channel 203 does not show strong frequency selectivity (e.g., Hₖ₊₁≅Hₖ₋₁), the phase of the product term may be represented by Equation 12 below:

$${α}_{k} ≅ \frac{4}{{π}^{2}} {\vert {H}_{k - 1} \vert}^{2} {\vert {X}_{k} \vert}^{2} {e}^{- j \frac{4 π {n}_{0}}{N}} \qquad ( 12 )$$

where αₖ is based on (and represents) the modulation phase. As can be seen in Equation 12, the term |Hₖ₋₁|² is a real value, and the Rx device 215 can therefore easily measure the modulation phase αₖ and obtain the phase shift n₀. That is, in accordance with Equation 12, the Rx device 215 may be able to compare subcarriers k−1 and k+1 to estimate the modulation phase and thereby determine the phase shift without having to perform channel estimation.

In another example, the backscatter channel 203 may not be sufficiently flat fading (e.g., the channel affects different subcarriers differently), and the phase contribution of the composite channel product

$${H}_{k - 1}^{*} {H}_{k + 1}$$

is eliminated by using long-term channel autocorrelation (i.e., r(2)), as shown and described in Equations 13 and 14 below:

$$r ( 2 ) = \frac{1}{{N}_{0}} {\sum }_{k} {H}_{k - 1}^{*} {H}_{k + 1} \qquad ( 13 )$$

$${α}_{k} ≅ \frac{4}{{π}^{2}} r ( 2 ) {\vert {X}_{k} \vert}^{2} {e}^{- j \frac{4 π {n}_{0}}{N}} \qquad ( 14 )$$

where r(2) represents a channel autocorrelation metric associated with the forward channel 201 and/or the backscatter channel 203, Nₒ represents occupied subcarriers 315, and αₖ/r(2) represents the modulation phase. As shown in Equation 13, there are multiple occasions where the multiplication

$${H}_{k - 1}^{*} {H}_{k + 1}$$

may be performed, namely, for each occupied subcarrier 315. As such, this multiplication

$${H}_{k - 1}^{*} {H}_{k + 1}$$

may be represented by the instantaneous value of the channel autocorrelation metric r(2), which may be available to the Rx device 215 (e.g., communicated by the Tx device 205). Therefore, in cases where the channel autocorrelation metric r(2) is available to the Rx device 215, the Rx device 215 may replace the multiplication

$${H}_{k - 1}^{*} {H}_{k + 1}$$

with the channel autocorrelation metric r(2) (as shown in Equation 14), thereby enabling the Rx device 215 to easily measure the modulation phase αₖ and obtain the phase shift n₀ without having to perform channel estimation.

By way of another example, for constant-envelope symbols such as for QPSK (e.g., for constant-energy emitter signals 225/backscattered signals 230), the energy of each constellation point may be approximately equal such that where |Xₖ|²=ϵ for ∀ k. In this regard, the phase αₖ may be estimated by taking the average phase across all occupied subcarriers 315, as shown by Equation 15 below:

$${\overline{α}}_{k} = \frac{1}{{N}_{o}} {\sum }_{k} {α}_{k} = \frac{4 ε}{{π}^{2}} {e}^{- j \frac{4 π {n}_{0}}{N}} \frac{1}{{N}_{o}} {\sum }_{k} {H}_{k - 1}^{*} {H}_{k + 1} = \frac{4 ε}{{π}^{2}} {e}^{- j \frac{4 π {n}_{0}}{N}} r ( 2 ) \qquad ( 15 )$$

where r(2) represents a channel autocorrelation metric associated with the forward channel 201 and/or the backscatter channel 203, Nₒ represents occupied subcarriers 315, and αₖ/r(2) represents the modulation phase. Once again, using Equation 15 (and assuming a constant-energy backscattered signal 305), the Rx device 215 may be configured to easily measure the modulation phase αₖ and obtain the phase shift n₀ without having to perform channel estimation.

In some aspects, the Rx device 215 may be configured to decode/demodulate the received backscattered signal 305 using one of the approaches identified above (e.g., using one of Equation 12, Equation 14, or Equation 15), based on what information is available to the Rx device 215, or which information may be obtained. For example, the Rx device 215 may demodulate the backscattered signal 305 according to Equation 12 if the channel flatness information indicates the backscatter channel does not show strong frequency selectivity (e.g., flat channel). Comparatively, the Rx device 215 may demodulate the backscattered signal 305 according to Equation 14 if the Rx device 215 knows the channel autocorrelation metric r(2), and may demodulate the backscattered signal 305 according to Equation 15 if the Rx device 215 knows the channel autocorrelation metric r(2) and the backscattered signal 305 includes a constant-energy signal (e.g., constant envelope signal).

As such, for bistatic settings in which the Rx device 215 is different from the Tx device 205, the Rx device 215 may request a) channel flatness information, and/or b) the channel autocorrelation metric r(2) for the backscatter channel 203, and the Tx device 205 may respond accordingly (as described herein). Comparatively, for monostatic settings in which the Rx device 215 and the Tx device 205 are the same, the Rx/Tx device may benefit from reciprocity of the forward channel 201 and backscatter channel 203, further simplifying the determination of the modulation phase and phase shift. Further, in monostatic settings, the Rx device 215 may not have to request channel flatness information and/or the channel autocorrelation metric, as the Tx device 205 and the Rx device 215 are the same.

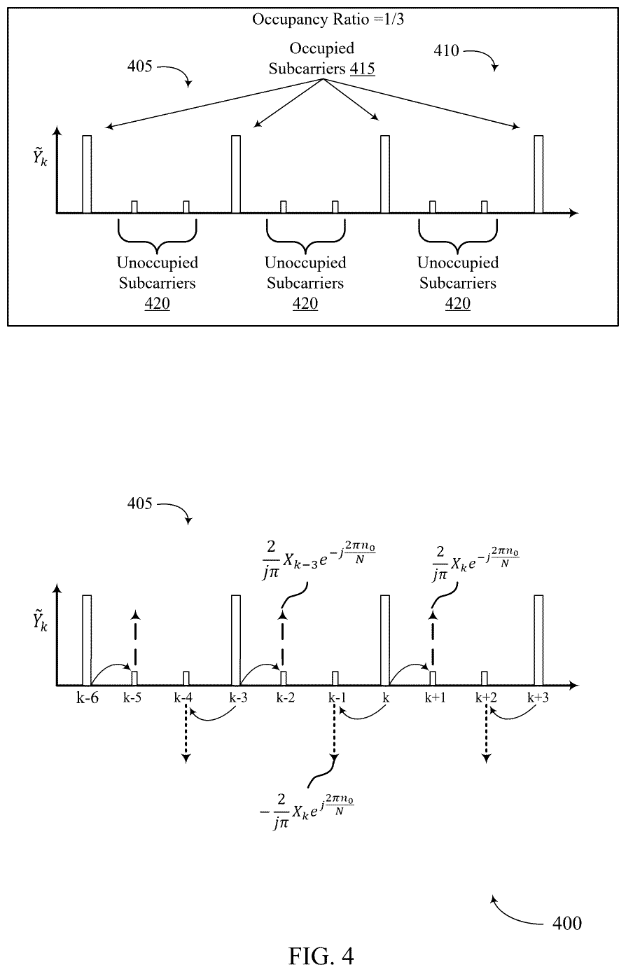

FIG. 4 shows an example of a signaling diagram 400 that supports techniques for fully-noncoherent frequency-domain detectors in accordance with one or more aspects of the present disclosure. Aspects of the signaling diagram 400 may implement, or be implemented by, aspects of the wireless communications system 100, the wireless communications system 200, the signaling diagram 300, or any combination thereof.

The signaling diagram 400 illustrates an example backscattered signal 405, which may be an example of the backscattered signal 230 (and/or synchronization signals) shown and described with respect to FIG. 2. As noted previously herein, the backscattered signal 405 may be transmitted according to a subcarrier allocation configuration 410 (which may be the same subcarrier allocation configuration 410 used for synchronization signals exchanged between the respective devices during a synchronization procedure). That is, the backscattered signals 405 may be associated with the subcarrier allocation configuration 410 (e.g., occupancy ratio) that includes a set of occupied subcarriers 415 (e.g., occupied REs) that are interleaved with a set of unoccupied subcarriers 420 (e.g., unoccupied REs).

For instance, FIG. 4 illustrates an example of a subcarrier allocation configuration 410 with an occupancy ratio of 1/3. In this regard, there is one occupied subcarrier 415 for every three subcarriers (e.g., two unoccupied subcarriers 420 per occupied subcarrier 415).

In some implementations, if the backscatter channel 203 is frequency selective (e.g., channel affects different subcarriers differently), the Tx device 205 may employ more occupied subcarriers/REs. That is, the Tx device 205 may use emitter signals 225/backscattered signals 230, 405 with a higher occupancy ratio, as shown in FIG. 4. With a higher occupancy ratio (e.g., larger subcarrier allocation configuration 410), the composite channel product may consist of “closer” samples and, hence, may be more likely to be real-valued. For instance, with the higher occupancy ratio shown in FIG. 4, the occupied subcarriers 415 may be closer together as compared to the lower occupancy ratio in FIG. 3.

In such cases with a frequency-selective backscatter channel 203, the Rx device 215 may employ multiple different options for demodulating the backscattered signal 405, as shown in Equations 16 and 17 below:

$${α}_{k} ≅ {H}_{k - 2}^{*} {H}_{k - 1} \frac{4}{{π}^{2}} {X}_{k - 3}^{*} {X}_{k} {e}^{j \frac{4 π {n}_{0}}{N}} \qquad ( 16 )$$

$${α}_{k} ≅ {H}_{k - 1}^{*} {H}_{k + 1} \frac{4}{{π}^{2}} {\vert {X}_{k} \vert}^{2} {e}^{- j \frac{4 π {n}_{0}}{N}} \qquad ( 17 )$$

Referring to Equation 16 above, the term

$${H}_{k - 2}^{*} {H}_{k - 1}$$

may result in less variation due to the backscatter channel 203 (as the term is looking at channel conditions between adjacent subcarriers k−2 and k−1, where Δk=1). However, the term

$${X}_{k - 3}^{*} {X}_{k}$$

(which is represented by Equation 18 below) may result in more variation due to the forward channel (as the term is looking at the emitter signal 225 across non-adjacent subcarriers k−3 and k, where Δk=3). As such, the Rx device 215 may use only known symbols (e.g., DMRS) with a suitable pattern, but where non-zero phase is now due to forward channel 201.

$${X}_{k - 3}^{*} {X}_{k} = ( {H}_{k - 3}^{E \to D} ) * {H}_{k}^{E \to D} ( {X}_{k - 3}^{@ E} ) * {X}_{k}^{@ E} \qquad ( 18 )$$

Comparatively, referring to Equation 17 above, the term

$${H}_{k - 1}^{*} {H}_{k + 1}$$

may result in more variation due to the backscatter channel 203 (as the term is looking at channel conditions between non-adjacent subcarriers k−1 and k+1, where Δk=2), where the term |Xₖ|² may indicate a non-zero phase. As such, the Rx device may not need to know Xₖ a priori. That is, the emitter signal 225

$$( {X}_{k}^{@ E} )$$

may be unknown, and the Rx device 215 may still estimate the modulation phase αₖ (and determine the phase shift n₀) without estimating the channel

$${H}_{k}^{E \to D} .$$

Taken together, the Rx device 215 may be configured to demodulate the backscattered signal 405 using Equation 17 above if the backscatter channel 203 is more frequency-selective than the forward channel 201. Otherwise, the Rx device 215 may be configured to demodulate the backscattered signal 405 using Equation 18 above if the forward channel 201 is more frequency-selective than the backscatter channel 203.

In some cases, the Rx device 215 may determine or otherwise estimate which channel is more frequency-selective (and therefore select which equation to use) based on relative distances between the respective devices. For example, if the reflector device 210 (e. tag) is closer to the Tx device 205 than the Rx device 215, the backscatter channel 203 may be longer, and may therefore be more frequency-selective than the forward channel 201 (which may cause the Rx device 215 to demodulate the backscattered signal using Equation 17). Conversely, if the reflector device 210 (e. tag) is closer to the Rx device 215 than the Tx device 205, the forward channel 201 may be longer, and may therefore be more frequency-selective than the backscatter channel 203 (which may cause the Rx device 215 to demodulate the backscattered signal using Equation 18).

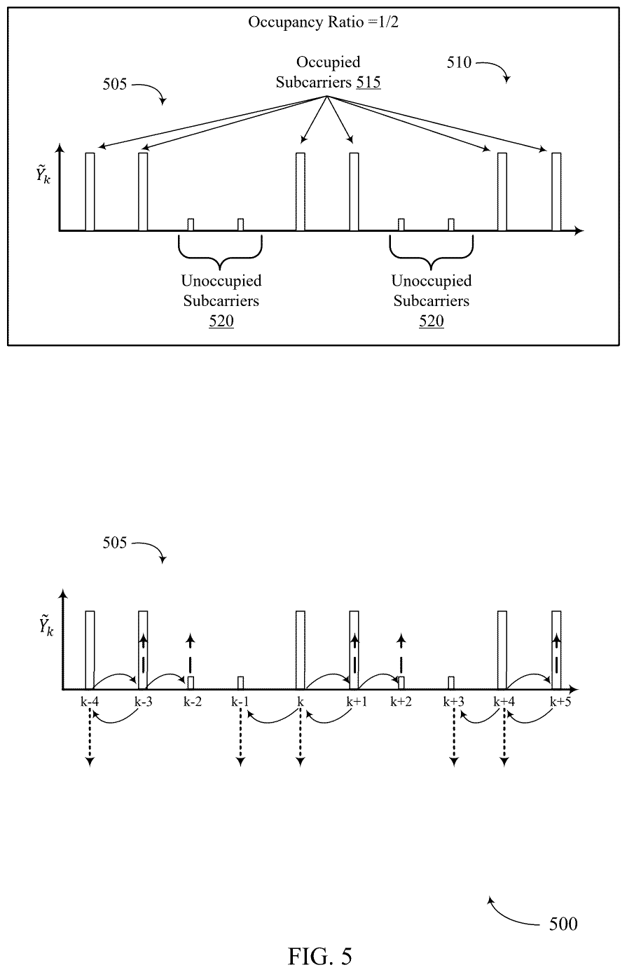

FIG. 5 shows an example of a signaling diagram 500 that supports techniques for fully-noncoherent frequency-domain detectors in accordance with one or more aspects of the present disclosure. Aspects of the signaling diagram 500 may implement, or be implemented by, aspects of the wireless communications system 100, the wireless communications system 200, the signaling diagram 300, the signaling diagram 400, or any combination thereof.

The signaling diagram 500 illustrates an example backscattered signal 505, which may be an example of the backscattered signal 230 (and/or synchronization signals) shown and described with respect to FIG. 2. As noted previously herein, the backscattered signal 505 may be transmitted according to a subcarrier allocation configuration 510 (which may be the same subcarrier allocation configuration 510 used for synchronization signals exchanged between the respective devices during a synchronization procedure). That is, the backscattered signals 505 may be associated with the subcarrier allocation configuration 510 (e.g., occupancy ratio) that includes a set of occupied subcarriers 515 (e.g., occupied REs) that are interleaved with a set of unoccupied subcarriers 520 (e.g., unoccupied REs).

For instance, FIG. 5 illustrates an example of a subcarrier allocation configuration 510 with an occupancy ratio of 1/52. In this regard, there is one occupied subcarrier 515 for every unoccupied subcarrier 520 (e.g., two unoccupied subcarriers 520 per two occupied subcarriers 515).

In some implementations, a denser subcarrier allocation configuration (such as the subcarrier allocation configuration 510) at the Tx device 205 may improve detection and demodulation over a frequency-selective backscatter channel 203 but at the expense of smaller energy per occupied subcarrier 515). In such cases, with a frequency-selective backscatter channel 203, the Rx device 215 may demodulate the backscattered signal 405 according to Equation 17 above and/or Equation 19 below:

$${α}_{k} ≅ {H}_{k} {H}_{k + 1}^{*} \frac{4}{{π}^{2}} {X}_{k + 1} {X}_{k}^{*} {e}^{j \frac{4 π {n}_{0}}{N}} \qquad ( 19 )$$

Referring to Equation 19 above, the term

$${H}_{k} {H}_{k + 1}^{*}$$

may result in less variation due to the backscatter channel 203 (as the term is looking at channel conditions between adjacent subcarriers k and k+1, where Δk=1). Further, the term

$${X}_{k + 1}^{*} {X}_{k}$$

may also result in less variation due to the forward channel (as the term is looking at the emitter signal 225 across adjacent subcarriers k and k+1, where Δk=1).

In some implementations, the Rx device 215 may be configured to use one (or more) of the equations/techniques described herein to estimate the modulation phase (and phase shift) of the received backscattered signal 230, 305, 405, 505. For example, as described previously herein, the Rx device 215 may select one (or more) of the equations described herein to demodulate the backscattered signal based on the information that is available to the Rx device 215 (e.g., channel flatness information, channel autocorrelation metric, distance between the respective devices, etc.).

Moreover, for any received symbol/occupied subcarrier 315, 415, 515, the Rx device 215 may estimate the modulation phase (and phase shift) of the backscattered signal using any of the equations/techniques described herein simultaneously (or in parallel) to improve detection results. For example, for a received backscattered signal, the Rx device 215 may estimate the modulation phase (and phase shift) using Equation 16 for a first occupied subcarrier 315, 415, 515, and may estimate the modulation phase (and phase shift) using use Equation 17 or Equation 19 for a second occupied subcarrier 315, 415, 515. In such cases, the Rx device 215 may be configured to average or otherwise combine the respective estimates of the modulation phase/phase shift in order to demodulate the backscattered signal and decode the data payload.

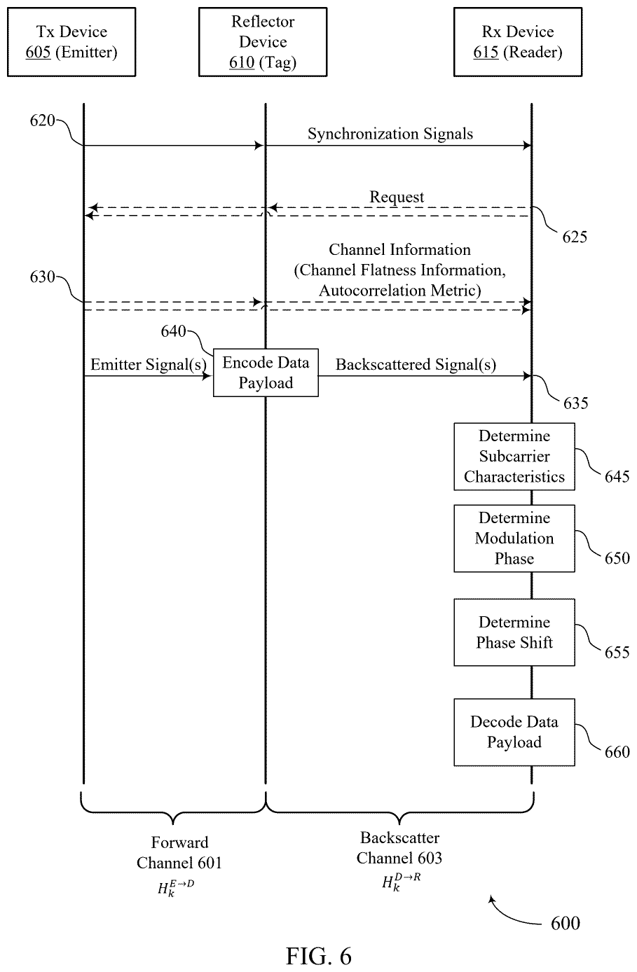

FIG. 6 shows an example of a process flow 600 that supports techniques for fully-noncoherent frequency-domain detectors in accordance with one or more aspects of the present disclosure. Aspects of the process flow 600 may implement, or be implemented by, aspects of the wireless communications system 100, the wireless communications system 200, the signaling diagram 300, the signaling diagram 400, the signaling diagram 500, or any combination thereof.

The process flow 600 includes a Tx device 605, a reflector device 610, and an Rx device 615, which may be examples of wireless devices as described herein. For example, the Tx device 605, the reflector device 610, and the Rx device 615 shown and described in FIG. 6 may be examples of the Tx device 205, the reflector device 210, and the Rx device 215, respectively, as illustrated in FIG. 2. In this regard, the reflector device 610 may additionally, or alternatively, be referred to as a “backscatter capable” device that is configured to receive emitter signals from the Tx device 605 via a forward channel 601, and reflect or otherwise relay the signals to the Rx device 615 via a backscatter channel 603. The reflector device 610 may include a RFID tag, an A-IoT device, a RIS, or any combination thereof. In some aspects, the Tx device 605 and the Rx device 615 may be different devices, or may be the same device. That is, in some cases, the same device that “queries” the reflector device 610 (e.g., RFID tag) via the emitter signals may be the same device that reads the backscattered signals 230 reflected/transmitted back from the reflector device 610.

In some examples, the operations illustrated in process flow 600 may be performed by hardware (e.g., including circuitry, processing blocks, logic components, and other components), code (e.g., software or firmware) executed by a processor, or any combination thereof. Alternative examples of the following may be implemented, where some steps are performed in a different order than described or are not performed at all. In some cases, steps may include additional features not mentioned below, or further steps may be added.

At signaling operation 620, the Rx device 615 may receive, over the backscatter channel 603, one or more synchronization signals from the Tx device 605 that are reflected or otherwise relayed via the reflector device 610 (e.g., backscatter-capable device). In some aspects, the synchronization signals may be exchanged as part of a synchronization procedure between the respective wireless devices.

The synchronization signals may be associated with a subcarrier allocation configuration that includes a set of occupied subcarriers interleaved with a set of unoccupied subcarriers, as shown and described with respect to FIGS. 3-5. In some aspects, the subcarrier allocation configuration may be based on an energy consumption constraint associated with the Tx device 605, the Rx device 615, or both.

At signaling operation 625, the Rx device 615 may transmit, to the Tx device 605, a request for information that will enable the Rx device 615 to decode/demodulate backscattered signals received from the reflector device 610. In some cases, the Rx device 615 may transmit the request based on receiving the synchronization signals at signaling operation 620. In some aspects, the Rx device 615 may transmit the request to the Tx device 605 directly, and/or via the reflector device 610.

For example, the request may include a request for channel flatness information associated with the forward channel 601 and/or the backscatter channel 603, where the channel flatness information is associated with characteristics of the forward channel 601 and/or the backscatter channel 603 across a frequency domain. That is, channel flatness information may indicate how different frequencies are affected across the forward channel 601 and/or the backscatter channel 603. By way of another example, the request may include a request for a channel autocorrelation metric associated with the forward channel 601 and/or the backscatter channel 603. As described previously herein, the channel flatness information and/or the autocorrelation metric may be usable by the Rx device 615 to decode/demodulate backscattered signals received from the reflector device 610.

At signaling operation 630, the Rx device 615 may receive information from the Tx device 605 that is usable for decoding/demodulating backscattered signals received from the reflector device 610. For example, the Rx device 615 may receive channel flatness information, a channel autocorrelation metric, or both. The Rx device 615 may receive the information based on receiving the synchronization signals at signaling operation 620, transmitting the request at signaling operation 625, or both.

At signaling operation 635, the Rx device 615 may receive one or more backscattered signals from the reflector device 610. For example, as described previously herein, the Tx device 605 may transmit emitter signals to the reflector device 610 via the forward channel 601. At encoding operation 640, the reflector device 610 may encode the emitter signals with a data payload, and may reflect or otherwise relay the signals to the Rx device 615 (with the encoded data payload) as backscattered signals via the backscatter channel 603. For example, as shown and described with reference to the diagrams 250 in FIG. 2, the reflector device 610 may encode the data payload by shifting the emitter signals by a phase shift n₀.

As noted previously herein, the backscattered signal may be transmitted according to the same subcarrier allocation configuration associated with the synchronization signals. That is, the backscattered signals may be associated with the subcarrier allocation configuration (e.g., occupancy ratio) that includes a set of occupied subcarriers that are interleaved with a set of unoccupied subcarriers. For example, FIGS. 3-5 illustrate different subcarrier allocation configurations with occupancy ratios of 1/4, 1/3, and 1/2, respectively.

At processing operation 645, the Rx device 615 may determine one or more characteristics across respective subcarriers of the backscattered signal(s). In particular, the Rx device 615 may determine characteristics across the respective subcarriers of the backscattered signal based on receiving the synchronization signals at signaling operation 620, receiving the channel flatness information and/or autocorrelation metric at signaling operation 630, or both.

For example, the Rx device 615 may determine that one or more characteristics of a first subcarrier of the backscattered signal(s) are the same (or similar) to one or more additional characteristics of a second subcarrier of the backscattered signal(s) based on the channel flatness information. In other words, the Rx device 615 may determine that the channel characteristics of the forward channel 601 and/or the backscatter channel 603 remain relatively constant in the frequency domain (at least when considering subcarriers that are adjacent or otherwise close to one another in the frequency domain).

At processing operation 650, the Rx device 615 may determine a modulation phase (e.g., determine

$$j \frac{π {n}_{0} ℓ M}{N}$$

and/or in Equation 2 above) of the backscattered signal(s) based on a comparison between multiple subcarriers of the backscattered signal. The Rx device 615 may determine the modulation phase based on receiving the synchronization signals at signaling operation 620, receiving the channel information (e.g., channel flatness information, channel autocorrelation metric) at signaling operation 630, receiving the backscattered signals at signaling operation 635, determining the subcarrier characteristic(s) at processing operation 645, or any combination thereof.

For example, the Rx device 615 may determine a modulation phase (e.g., determine

$$j \frac{π {n}_{0} ℓ M}{N}$$

and/or αₖ in Equations 2, 11, 12, 14-17, and 19 above) of the backscattered signal based on a comparison between a first subcarrier and a second subcarrier of the backscattered signal. In some cases, the modulation phase may be determined based on the channel flatness information across at least the first subcarrier and the second subcarrier. In this example, the first subcarrier and the second subcarrier may be determined relative to at least one occupied subcarrier of the set of occupied subcarriers based on the subcarrier allocation configuration, as shown and described in FIGS. 3-5.

The Rx device 615 may identify/select the subcarriers of the backscattered signal that are used/compared to determine the modulation phase according to one or more parameters, rules, or characteristics. For example, in some cases, the first and second subcarriers that are compared to determine the modulation phase may be identified/determined based on a comparison between channel flatness information of the forward channel and channel flatness information of the backscatter channel. By way of another example, the Rx device 615 may identify/select the first and second subcarriers that are compared to determine the modulation phase based on a first distance between the Tx device 605 and the reflector device 610, a second distance between the reflector device 610 and the Rx device 615, or both.

In additional or alternative implementations, the modulation phase may be determined based on the channel autocorrelation metric, and/or based on the emitter signal transmitted by the Tx device 605 including a constant energy signal.

At processing operation 655, the Rx device 615 may determine a phase shift (n₀) of the backscattered signal. In particular, the Rx device 615 may determine the phase shift (n₀) based on the modulation phase

$$( j \frac{π {n}_{0} ℓ M}{N} )$$

determined at processing operation 650. That is, the Rx device 615 may determine phase shift (n₀) according to one (or more) of Equations 2, 11, 12, 14-17, and 19 above.

At processing operation 660, the Rx device 615 may decode the data payload from the backscattered signal. That is, the Rx device 615 may decode the data payload encoded into the backscattered signal by the reflector device at encoding operation 640. The Rx device 615 may decode the data payload based on the phase shift (n₀) determined at processing operation 645, the modulation phase

$$( j \frac{π {n}_{0} ℓ M}{N} )$$

determined at processing operation 650, or both.

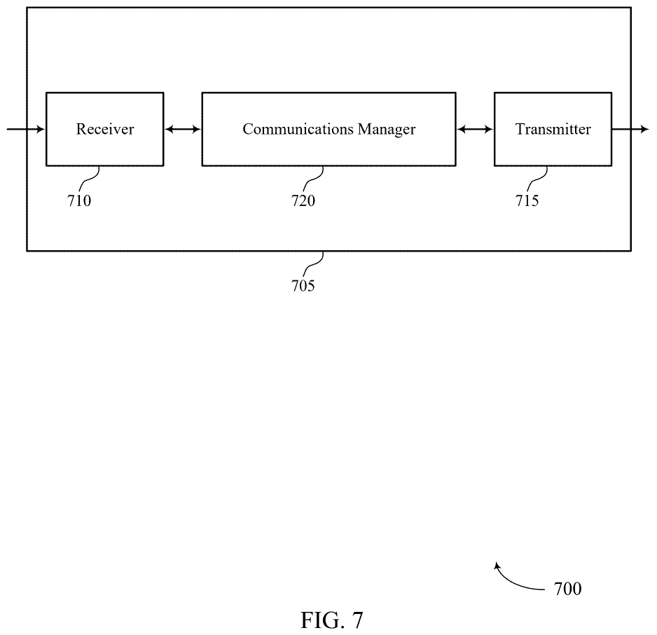

FIG. 7 shows a block diagram 700 of a device 705 that supports techniques for fully-noncoherent frequency-domain detectors in accordance with one or more aspects of the present disclosure. The device 705 may be an example of aspects of a UE 115 as described herein. The device 705 may include a receiver 710, a transmitter 715, and a communications manager 720. The device 705, or one or more components of the device 705 (e.g., the receiver 710, the transmitter 715, the communications manager 720), may include at least one processor, which may be coupled with at least one memory, to, individually or collectively, support or enable the described techniques. Each of these components may be in communication with one another (e.g., via one or more buses).

The receiver 710 may provide a means for receiving information such as packets, user data, control information, or any combination thereof associated with various information channels (e.g., control channels, data channels, information channels related to techniques for fully-noncoherent frequency-domain detectors). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to techniques for fully-noncoherent frequency-domain detectors). In some examples, the transmitter 715 may be co-located with a receiver 710 in a transceiver module. The transmitter 715 may utilize a single antenna or a set of multiple antennas.

The communications manager 720, the receiver 710, the transmitter 715, or various combinations or components thereof may be examples of means for performing various aspects of techniques for fully-noncoherent frequency-domain detectors as described herein. For example, the communications manager 720, the receiver 710, the transmitter 715, or various combinations or components thereof may be capable of performing one or more of the functions described herein.

In some examples, the communications manager 720, the receiver 710, the transmitter 715, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 720, the receiver 710, the transmitter 715, or various combinations or components thereof may be implemented in code (e.g., as communications management software or firmware) executed by at least one processor (e.g., referred to as a processor-executable code). If implemented in code executed by at least one processor, the functions of the communications manager 720, the receiver 710, the transmitter 715, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 720 may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

For example, the communications manager 720 is capable of, configured to, or operable to support a means for receiving, over a backscatter channel, one or more synchronization signals from a Tx device via a backscatter-capable device, where the one or more synchronization signals are associated with a subcarrier allocation configuration including a set of occupied subcarriers interleaved with a set of unoccupied subcarriers. The communications manager 720 is capable of, configured to, or operable to support a means for receiving a backscattered signal from the backscatter-capable device via the backscatter channel, the backscattered signal based on an emitter signal from the Tx device and a data payload from the backscatter-capable device. The communications manager 720 is capable of, configured to, or operable to support a means for determining a modulation phase of the backscattered signal based on a comparison between at least a first subcarrier and a second subcarrier of the backscattered signal, where the first subcarrier and the second subcarrier are determined relative to at least one occupied subcarrier of the set of occupied subcarriers based on the subcarrier allocation configuration. The communications manager 720 is capable of, configured to, or operable to support a means for decoding the data payload from the backscattered signal based on a phase shift of the backscattered signal, where the phase shift is determined based on the modulation phase.

By including or configuring the communications manager 720 in accordance with examples as described herein, the device 705 (e.g., at least one processor controlling or otherwise coupled with the receiver 710, the transmitter 715, the communications manager 720, or a combination thereof) may support techniques for efficient frequency-domain demodulation without channel estimation, which may enable Rx devices to demodulate backscattered signals with lower processing resources, thereby reducing power consumption and improving battery performance.

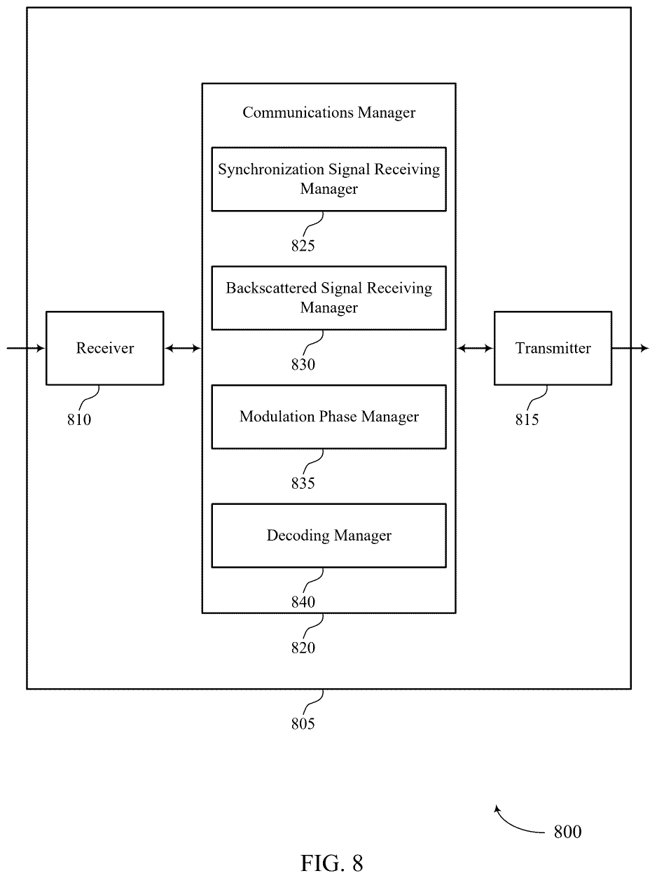

FIG. 8 shows a block diagram 800 of a device 805 that supports techniques for fully-noncoherent frequency-domain detectors in accordance with one or more aspects of the present disclosure. The device 805 may be an example of aspects of a device 705 or a UE 115 as described herein. The device 805 may include a receiver 810, a transmitter 815, and a communications manager 820. The device 805, or one or more components of the device 805 (e.g., the receiver 810, the transmitter 815, the communications manager 820), may include at least one processor, which may be coupled with at least one memory, to support the described techniques. Each of these components may be in communication with one another (e.g., via one or more buses).

The receiver 810 may provide a means for receiving information such as packets, user data, control information, or any combination thereof associated with various information channels (e.g., control channels, data channels, information channels related to techniques for fully-noncoherent frequency-domain detectors). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to techniques for fully-noncoherent frequency-domain detectors). In some examples, the transmitter 815 may be co-located with a receiver 810 in a transceiver module. The transmitter 815 may utilize a single antenna or a set of multiple antennas.

The device 805, or various components thereof, may be an example of means for performing various aspects of techniques for fully-noncoherent frequency-domain detectors as described herein. For example, the communications manager 820 may include a synchronization signal receiving manager 825, a backscattered signal receiving manager 830, a modulation phase manager 835, a decoding manager 840, or any combination thereof. The communications manager 820 may be an example of aspects of a communications manager 720 as described herein. In some examples, the communications manager 820, or various components thereof, may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The synchronization signal receiving manager 825 is capable of, configured to, or operable to support a means for receiving, over a backscatter channel, one or more synchronization signals from a Tx device via a backscatter-capable device, where the one or more synchronization signals are associated with a subcarrier allocation configuration including a set of occupied subcarriers interleaved with a set of unoccupied subcarriers. The backscattered signal receiving manager 830 is capable of, configured to, or operable to support a means for receiving a backscattered signal from the backscatter-capable device via the backscatter channel, the backscattered signal based on an emitter signal from the Tx device and a data payload from the backscatter-capable device. The modulation phase manager 835 is capable of, configured to, or operable to support a means for determining a modulation phase of the backscattered signal based on a comparison between at least a first subcarrier and a second subcarrier of the backscattered signal, where the first subcarrier and the second subcarrier are determined relative to at least one occupied subcarrier of the set of occupied subcarriers based on the subcarrier allocation configuration. The decoding manager 840 is capable of, configured to, or operable to support a means for decoding the data payload from the backscattered signal based on a phase shift of the backscattered signal, where the phase shift is determined based on the modulation phase.

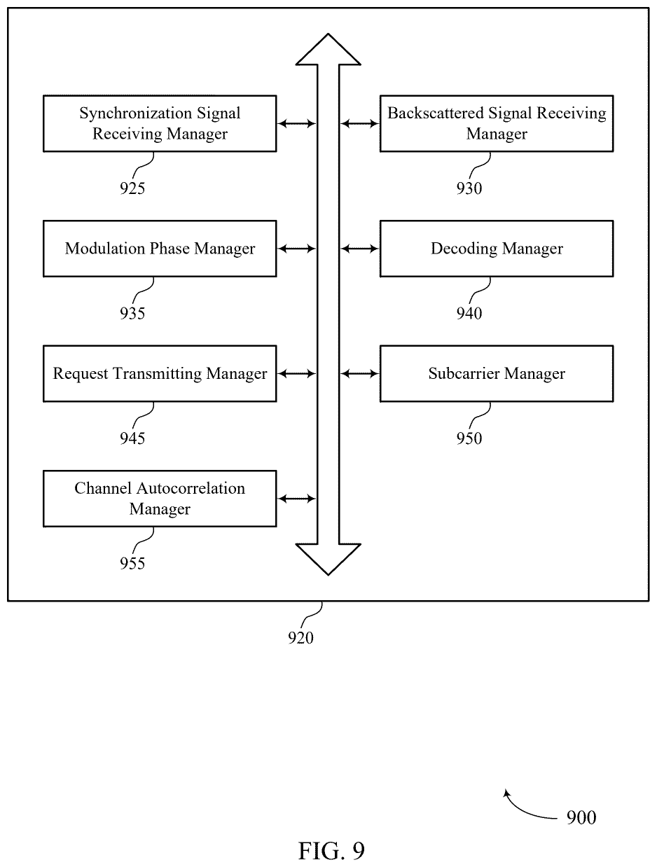

FIG. 9 shows a block diagram 900 of a communications manager 920 that supports techniques for fully-noncoherent frequency-domain detectors in accordance with one or more aspects of the present disclosure. The communications manager 920 may be an example of aspects of a communications manager 720, a communications manager 820, or both, as described herein. The communications manager 920, or various components thereof, may be an example of means for performing various aspects of techniques for fully-noncoherent frequency-domain detectors as described herein. For example, the communications manager 920 may include a synchronization signal receiving manager 925, a backscattered signal receiving manager 930, a modulation phase manager 935, a decoding manager 940, a request transmitting manager 945, a subcarrier manager 950, a channel autocorrelation manager 955, or any combination thereof. Each of these components, or components or subcomponents thereof (e.g., one or more processors, one or more memories), may communicate, directly or indirectly, with one another (e.g., via one or more buses).

The synchronization signal receiving manager 925 is capable of, configured to, or operable to support a means for receiving, over a backscatter channel, one or more synchronization signals from a Tx device via a backscatter-capable device, where the one or more synchronization signals are associated with a subcarrier allocation configuration including a set of occupied subcarriers interleaved with a set of unoccupied subcarriers. The backscattered signal receiving manager 930 is capable of, configured to, or operable to support a means for receiving a backscattered signal from the backscatter-capable device via the backscatter channel, the backscattered signal based on an emitter signal from the Tx device and a data payload from the backscatter-capable device. The modulation phase manager 935 is capable of, configured to, or operable to support a means for determining a modulation phase of the backscattered signal based on a comparison between at least a first subcarrier and a second subcarrier of the backscattered signal, where the first subcarrier and the second subcarrier are determined relative to at least one occupied subcarrier of the set of occupied subcarriers based on the subcarrier allocation configuration. The decoding manager 940 is capable of, configured to, or operable to support a means for decoding the data payload from the backscattered signal based on a phase shift of the backscattered signal, where the phase shift is determined based on the modulation phase.

In some examples, the modulation phase is further determined based on channel flatness information of the backscatter channel across at least the first subcarrier and the second subcarrier, the channel flatness information associated with characteristics of the backscatter channel across a frequency domain.

In some examples, the request transmitting manager 945 is capable of, configured to, or operable to support a means for transmitting, to the Tx device, a request for the channel flatness information. In some examples, the decoding manager 940 is capable of, configured to, or operable to support a means for receiving the channel flatness information from the Tx device in response to the request.

In some examples, the subcarrier manager 950 is capable of, configured to, or operable to support a means for determining that one or more characteristics of the first subcarrier are the same or similar to one or more additional characteristics of the second subcarrier based on the channel flatness information, where the modulation phase is determined based on the one or more characteristics of the first subcarrier being the same or similar to the one or more additional characteristics of the second subcarrier.

In some examples, the modulation phase is further determined based on a channel autocorrelation metric associated with the backscatter channel.

In some examples, the request transmitting manager 945 is capable of, configured to, or operable to support a means for transmitting, to the Tx device, a request for the channel autocorrelation metric. In some examples, the channel autocorrelation manager 955 is capable of, configured to, or operable to support a means for receiving the channel autocorrelation metric from the Tx device in response to the request.

In some examples, the modulation phase is further determined based on the emitter signal including a constant-energy signal.

In some examples, the emitter signal is transmitted from the Tx device to the backscatter-capable device via a forward channel. In some examples, the subcarrier allocation configuration is based on channel flatness information of the backscatter channel, the forward channel, or both, across at least the first subcarrier and the second subcarrier, the channel flatness information associated with characteristics of the backscatter channel across a frequency domain.

In some examples, the first subcarrier and the second subcarrier are determined based on a comparison between first channel flatness information of the forward channel and second channel flatness information of the backscatter channel.

In some examples, the first subcarrier and the second subcarrier are determined based on a first distance between the Tx device and the backscatter-capable device, a second distance between the backscatter-capable device and the Rx device, or both.

In some examples, the subcarrier allocation configuration is based on an energy consumption constraint associated with the Tx device, the Rx device, or both.

In some examples, the Tx device and the Rx device include a single wireless communication device.

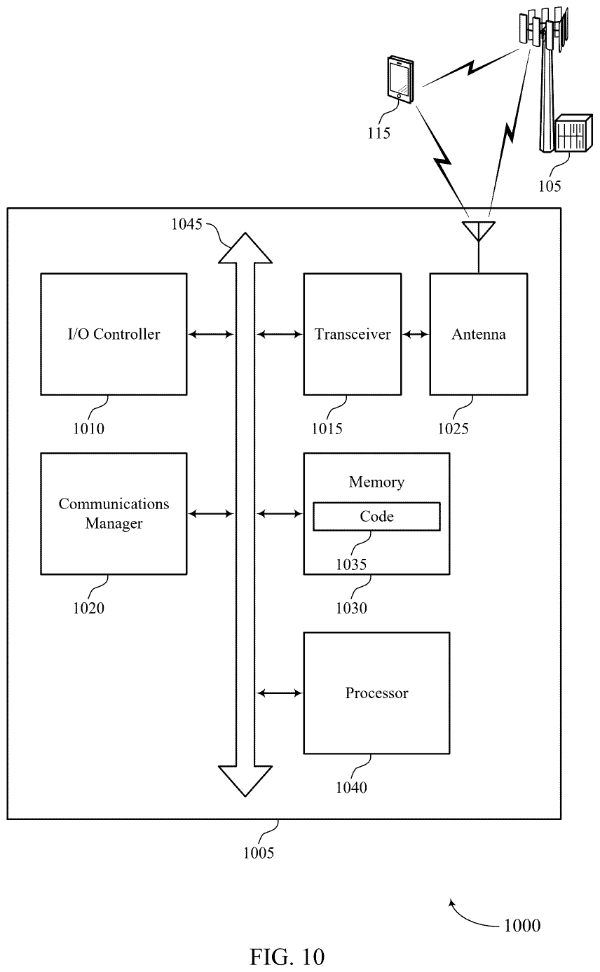

FIG. 10 shows a diagram of a system 1000 including a device 1005 that supports techniques for fully-noncoherent frequency-domain detectors in accordance with one or more aspects of the present disclosure. The device 1005 may be an example of or include components of a device 705, a device 805, or a UE 115 as described herein. The device 1005 may communicate (e.g., wirelessly) with one or more other devices (e.g., network entities 105, UEs 115, or a combination thereof). The device 1005 may include components for bi-directional voice and data communications including components for transmitting and receiving communications, such as a communications manager 1020, an input/output (I/O) controller, such as an I/O controller 1010, a transceiver 1015, one or more antennas 1025, at least one memory 1030, code 1035, and at least one processor 1040. These components may be in electronic communication or otherwise coupled (e.g., operatively, communicatively, functionally, electronically, electrically) via one or more buses (e.g., a bus 1045).

The I/O controller 1010 may manage input and output signals for the device 1005. The I/O controller 1010 may also manage peripherals not integrated into the device 1005. In some cases, the I/O controller 1010 may represent a physical connection or port to an external peripheral. In some cases, the I/O controller 1010 may utilize an operating system such as iOS®, ANDROID®, MS-DOS®, MS-WINDOWS®, OS/2®, UNIX®, LINUX®, or another known operating system. Additionally, or alternatively, the I/O controller 1010 may represent or interact with a modem, a keyboard, a mouse, a touchscreen, or a similar device. In some cases, the I/O controller 1010 may be implemented as part of one or more processors, such as the at least one processor 1040. In some cases, a user may interact with the device 1005 via the I/O controller 1010 or via hardware components controlled by the I/O controller 1010.

In some cases, the device 1005 may include a single antenna. However, in some other cases, the device 1005 may have more than one antenna, which may be capable of concurrently transmitting or receiving multiple wireless transmissions. The transceiver 1015 may communicate bi-directionally via the one or more antennas 1025 using wired or wireless links as described herein. For example, the transceiver 1015 may represent a wireless transceiver and may communicate bi-directionally with another wireless transceiver. The transceiver 1015 may also include a modem to modulate the packets, to provide the modulated packets to one or more antennas 1025 for transmission, and to demodulate packets received from the one or more antennas 1025. The transceiver 1015, or the transceiver 1015 and one or more antennas 1025, may be an example of a transmitter 715, a transmitter 815, a receiver 710, a receiver 810, or any combination thereof or component thereof, as described herein.

The at least one memory 1030 may include random access memory (RAM) and read-only memory (ROM). The at least one memory 1030 may store computer-readable, computer-executable, or processor-executable code, such as the code 1035. The code 1035 may include instructions that, when executed by the at least one processor 1040, cause the device 1005 to perform various functions described herein. The code 1035 may be stored in a non-transitory computer-readable medium such as system memory or another type of memory. In some cases, the code 1035 may not be directly executable by the at least one processor 1040 but may cause a computer (e.g., when compiled and executed) to perform functions described herein. In some cases, the at least one memory 1030 may include, among other things, a basic I/O system (BIOS) which may control basic hardware or software operation such as the interaction with peripheral components or devices.

The at least one processor 1040 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1040 may be configured to operate a memory array using a memory controller. In some other cases, a memory controller may be integrated into the at least one processor 1040. The at least one processor 1040 may be configured to execute computer-readable instructions stored in a memory (e.g., the at least one memory 1030) to cause the device 1005 to perform various functions (e.g., functions or tasks supporting techniques for fully-noncoherent frequency-domain detectors). For example, the device 1005 or a component of the device 1005 may include at least one processor 1040 and at least one memory 1030 coupled with or to the at least one processor 1040, the at least one processor 1040 and the at least one memory 1030 configured to perform various functions described herein.

In some examples, the at least one processor 1040 may include multiple processors and the at least one memory 1030 may include multiple memories. One or more of the multiple processors may be coupled with one or more of the multiple memories, which may, individually or collectively, be configured to perform various functions described herein. In some examples, the at least one processor 1040 may be a component of a processing system, which may refer to a system (such as a series) of machines, circuitry (including, for example, one or both of processor circuitry (which may include the at least one processor 1040) and memory circuitry (which may include the at least one memory 1030)), or components, that receives or obtains inputs and processes the inputs to produce, generate, or obtain a set of outputs. The processing system may be configured to perform one or more of the functions described herein. For example, the at least one processor 1040 or a processing system including the at least one processor 1040 may be configured to, configurable to, or operable to cause the device 1005 to perform one or more of the functions described herein. Further, as described herein, being “configured to,” being “configurable to,” and being “operable to” may be used interchangeably and may be associated with a capability, when executing code 1035 (e.g., processor-executable code) stored in the at least one memory 1030 or otherwise, to perform one or more of the functions described herein.

For example, the communications manager 1020 is capable of, configured to, or operable to support a means for receiving, over a backscatter channel, one or more synchronization signals from a Tx device via a backscatter-capable device, where the one or more synchronization signals are associated with a subcarrier allocation configuration including a set of occupied subcarriers interleaved with a set of unoccupied subcarriers. The communications manager 1020 is capable of, configured to, or operable to support a means for receiving a backscattered signal from the backscatter-capable device via the backscatter channel, the backscattered signal based on an emitter signal from the Tx device and a data payload from the backscatter-capable device. The communications manager 1020 is capable of, configured to, or operable to support a means for determining a modulation phase of the backscattered signal based on a comparison between at least a first subcarrier and a second subcarrier of the backscattered signal, where the first subcarrier and the second subcarrier are determined relative to at least one occupied subcarrier of the set of occupied subcarriers based on the subcarrier allocation configuration. The communications manager 1020 is capable of, configured to, or operable to support a means for decoding the data payload from the backscattered signal based on a phase shift of the backscattered signal, where the phase shift is determined based on the modulation phase.

By including or configuring the communications manager 1020 in accordance with examples as described herein, the device 1005 may support techniques for efficient frequency-domain demodulation without channel estimation, which may enable Rx devices to demodulate backscattered signals with lower processing resources, thereby reducing power consumption and improving battery performance.

In some examples, the communications manager 1020 may be configured to perform various operations (e.g., receiving, monitoring, transmitting) using or otherwise in cooperation with the transceiver 1015, the one or more antennas 1025, or any combination thereof. Although the communications manager 1020 is illustrated as a separate component, in some examples, one or more functions described with reference to the communications manager 1020 may be supported by or performed by the at least one processor 1040, the at least one memory 1030, the code 1035, or any combination thereof. For example, the code 1035 may include instructions executable by the at least one processor 1040 to cause the device 1005 to perform various aspects of techniques for fully-noncoherent frequency-domain detectors as described herein, or the at least one processor 1040 and the at least one memory 1030 may be otherwise configured to, individually or collectively, perform or support such operations.

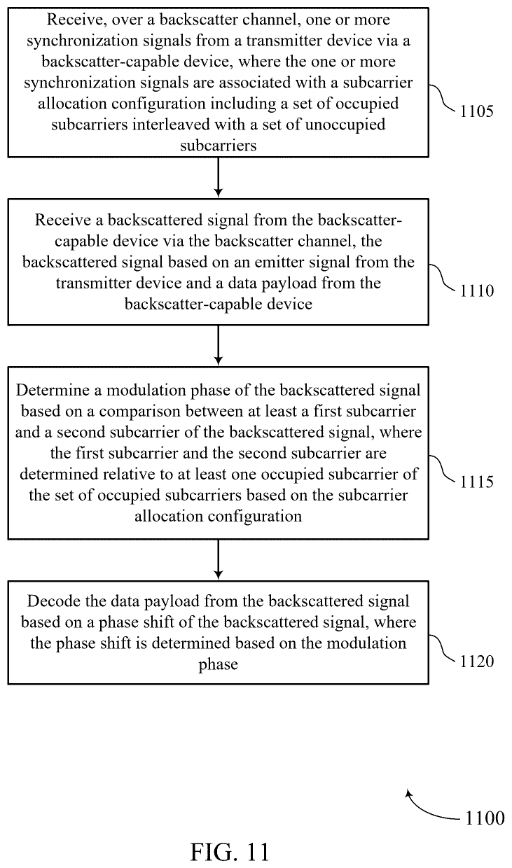

FIG. 11 shows a flowchart illustrating a method 1100 that supports techniques for fully-noncoherent frequency-domain detectors in accordance with one or more aspects of the present disclosure. The operations of the method 1100 may be implemented by a UE or its components as described herein. For example, the operations of the method 1100 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1105, the method may include receiving, over a backscatter channel, one or more synchronization signals from a Tx device via a backscatter-capable device, where the one or more synchronization signals are associated with a subcarrier allocation configuration including a set of occupied subcarriers interleaved with a set of unoccupied subcarriers. The operations of 1105 may be performed in accordance with examples as disclosed herein. In some examples, aspects of the operations of 1105 may be performed by a synchronization signal receiving manager 925 as described with reference to FIG. 9.

At 1110, the method may include receiving a backscattered signal from the backscatter-capable device via the backscatter channel, the backscattered signal based on an emitter signal from the Tx device and a data payload from the backscatter-capable device. The operations of 1110 may be performed in accordance with examples as disclosed herein. In some examples, aspects of the operations of 1110 may be performed by a backscattered signal receiving manager 930 as described with reference to FIG. 9.

At 1115, the method may include determining a modulation phase of the backscattered signal based on a comparison between at least a first subcarrier and a second subcarrier of the backscattered signal, where the first subcarrier and the second subcarrier are determined relative to at least one occupied subcarrier of the set of occupied subcarriers based on the subcarrier allocation configuration. The operations of 1115 may be performed in accordance with examples as disclosed herein. In some examples, aspects of the operations of 1115 may be performed by a modulation phase manager 935 as described with reference to FIG. 9.

At 1120, the method may include decoding the data payload from the backscattered signal based on a phase shift of the backscattered signal, where the phase shift is determined based on the modulation phase. The operations of 1120 may be performed in accordance with examples as disclosed herein. In some examples, aspects of the operations of 1120 may be performed by a decoding manager 940 as described with reference to FIG. 9.

The following provides an overview of aspects of the present disclosure:

Aspect 1: A method for wireless communications at an Rx device, comprising: receiving, over a backscatter channel, one or more synchronization signals from a Tx device via a backscatter-capable device, wherein the one or more synchronization signals are associated with a subcarrier allocation configuration comprising a set of occupied subcarriers interleaved with a set of unoccupied subcarriers; receiving a backscattered signal from the backscatter-capable device via the backscatter channel, the backscattered signal based at least in part on an emitter signal from the Tx device and a data payload from the backscatter-capable device; determining a modulation phase of the backscattered signal based at least in part on a comparison between at least a first subcarrier and a second subcarrier of the backscattered signal, wherein the first subcarrier and the second subcarrier are determined relative to at least one occupied subcarrier of the set of occupied subcarriers based at least in part on the subcarrier allocation configuration; and decoding the data payload from the backscattered signal based at least in part on a phase shift of the backscattered signal, wherein the phase shift is determined based at least in part on the modulation phase.

Aspect 2: The method of aspect 1, wherein the modulation phase is further determined based at least in part on channel flatness information of the backscatter channel across at least the first subcarrier and the second subcarrier, the channel flatness information associated with characteristics of the backscatter channel across a frequency domain.

Aspect 3: The method of aspect 2, further comprising: transmitting, to the Tx device, a request for the channel flatness information; and receiving the channel flatness information from the Tx device in response to the request.

Aspect 4: The method of any of aspects 2 through 3, further comprising: determining that one or more characteristics of the first subcarrier are the same or similar to one or more additional characteristics of the second subcarrier based at least in part on the channel flatness information, wherein the modulation phase is determined based at least in part on the one or more characteristics of the first subcarrier being the same or similar to the one or more additional characteristics of the second subcarrier.

Aspect 5: The method of any of aspects 1 through 4, wherein the modulation phase is further determined based at least in part on a channel autocorrelation metric associated with the backscatter channel.

Aspect 6: The method of aspect 5, further comprising: transmitting, to the Tx device, a request for the channel autocorrelation metric; and receiving the channel autocorrelation metric from the Tx device in response to the request.

Aspect 7: The method of any of aspects 5 through 6, wherein the modulation phase is further determined based at least in part on the emitter signal comprising a constant-energy signal.

Aspect 8: The method of any of aspects 1 through 7, wherein the emitter signal is transmitted from the Tx device to the backscatter-capable device via a forward channel, the subcarrier allocation configuration is based at least in part on channel flatness information of the backscatter channel, the forward channel, or both, across at least the first subcarrier and the second subcarrier, the channel flatness information associated with characteristics of the backscatter channel across a frequency domain.

Aspect 9: The method of aspect 8, wherein the first subcarrier and the second subcarrier are determined based at least in part on a comparison between first channel flatness information of the forward channel and second channel flatness information of the backscatter channel.

Aspect 10: The method of any of aspects 1 through 9, wherein the first subcarrier and the second subcarrier are determined based at least in part on a first distance between the Tx device and the backscatter-capable device, a second distance between the backscatter-capable device and the Rx device, or both.

Aspect 11: The method of any of aspects 1 through 10, wherein the subcarrier allocation configuration is based at least in part on an energy consumption constraint associated with the Tx device, the Rx device, or both.

Aspect 12: The method of any of aspects 1 through 11, wherein the Tx device and the Rx device comprise a single wireless communication device.

Aspect 13: An Rx device comprising one or more memories storing processor-executable code, and one or more processors coupled with the one or more memories and individually or collectively operable to execute the code to cause the Rx device to perform a method of any of aspects 1 through 12.

Aspect 14: An Rx device comprising at least one means for performing a method of any of aspects 1 through 12.

Aspect 15: A non-transitory computer-readable medium storing code the code comprising instructions executable by one or more processors to perform a method of any of aspects 1 through 12.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A receiver device, comprising:
one or more memories storing processor-executable code; and
one or more processors coupled with the one or more memories and individually or collectively operable to execute the code to cause the receiver device to:
receive, over a backscatter channel, one or more synchronization signals from a transmitter device via a backscatter-capable device, wherein the one or more synchronization signals are associated with a subcarrier allocation configuration comprising a set of occupied subcarriers interleaved with a set of unoccupied subcarriers;
receive a backscattered signal from the backscatter-capable device via the backscatter channel, the backscattered signal based at least in part on an emitter signal from the transmitter device and a data payload from the backscatter-capable device;
determine a modulation phase of the backscattered signal based at least in part on a comparison between at least a first subcarrier and a second subcarrier of the backscattered signal, wherein the first subcarrier and the second subcarrier are determined relative to at least one occupied subcarrier of the set of occupied subcarriers based at least in part on the subcarrier allocation configuration; and
decode the data payload from the backscattered signal based at least in part on a phase shift of the backscattered signal, wherein the phase shift is determined based at least in part on the modulation phase.

2. The receiver device of claim 1, wherein the modulation phase is further determined based at least in part on channel flatness information of the backscatter channel across at least the first subcarrier and the second subcarrier, the channel flatness information associated with characteristics of the backscatter channel across a frequency domain.

3. The receiver device of claim 2, wherein the one or more processors are individually or collectively further operable to execute the code to cause the receiver device to:
transmit, to the transmitter device, a request for the channel flatness information; and
receive the channel flatness information from the transmitter device in response to the request.

4. The receiver device of claim 2, wherein the one or more processors are individually or collectively further operable to execute the code to cause the receiver device to:
determine that one or more characteristics of the first subcarrier are the same or similar to one or more additional characteristics of the second subcarrier based at least in part on the channel flatness information, wherein the modulation phase is determined based at least in part on the one or more characteristics of the first subcarrier being the same or similar to the one or more additional characteristics of the second subcarrier.

5. The receiver device of claim 1, wherein the modulation phase is further determined based at least in part on a channel autocorrelation metric associated with the backscatter channel.

6. The receiver device of claim 5, wherein the one or more processors are individually or collectively further operable to execute the code to cause the receiver device to:
transmit, to the transmitter device, a request for the channel autocorrelation metric; and
receive the channel autocorrelation metric from the transmitter device in response to the request.

7. The receiver device of claim 5, wherein the modulation phase is further determined based at least in part on the emitter signal comprising a constant-energy signal.

8. The receiver device of claim 1, wherein the emitter signal is transmitted from the transmitter device to the backscatter-capable device via a forward channel, wherein the subcarrier allocation configuration is based at least in part on channel flatness information of the backscatter channel, the forward channel, or both, across at least the first subcarrier and the second subcarrier, the channel flatness information associated with characteristics of the backscatter channel across a frequency domain.

9. The receiver device of claim 8, wherein the first subcarrier and the second subcarrier are determined based at least in part on a comparison between first channel flatness information of the forward channel and second channel flatness information of the backscatter channel.

10. The receiver device of claim 1, wherein the first subcarrier and the second subcarrier are determined based at least in part on a first distance between the transmitter device and the backscatter-capable device, a second distance between the backscatter-capable device and the receiver device, or both.

11. The receiver device of claim 1, wherein the subcarrier allocation configuration is based at least in part on an energy consumption constraint associated with the transmitter device, the receiver device, or both.

12. The receiver device of claim 1, wherein the transmitter device and the receiver device comprise a single wireless communication device.

13. A method for wireless communications at a receiver device, comprising:
receiving, over a backscatter channel, one or more synchronization signals from a transmitter device via a backscatter-capable device, wherein the one or more synchronization signals are associated with a subcarrier allocation configuration comprising a set of occupied subcarriers interleaved with a set of unoccupied subcarriers;
receiving a backscattered signal from the backscatter-capable device via the backscatter channel, the backscattered signal based at least in part on an emitter signal from the transmitter device and a data payload from the backscatter-capable device;
determining a modulation phase of the backscattered signal based at least in part on a comparison between at least a first subcarrier and a second subcarrier of the backscattered signal, wherein the first subcarrier and the second subcarrier are determined relative to at least one occupied subcarrier of the set of occupied subcarriers based at least in part on the subcarrier allocation configuration; and
decoding the data payload from the backscattered signal based at least in part on a phase shift of the backscattered signal, wherein the phase shift is determined based at least in part on the modulation phase.

14. The method of claim 13, wherein the modulation phase is further determined based at least in part on channel flatness information of the backscatter channel across at least the first subcarrier and the second subcarrier, the channel flatness information associated with characteristics of the backscatter channel across a frequency domain.

15. The method of claim 14, further comprising:
transmitting, to the transmitter device, a request for the channel flatness information; and
receiving the channel flatness information from the transmitter device in response to the request.

16. The method of claim 14, further comprising:
determining that one or more characteristics of the first subcarrier are the same or similar to one or more additional characteristics of the second subcarrier based at least in part on the channel flatness information, wherein the modulation phase is determined based at least in part on the one or more characteristics of the first subcarrier being the same or similar to the one or more additional characteristics of the second subcarrier.

17. The method of claim 13, wherein the modulation phase is further determined based at least in part on a channel autocorrelation metric associated with the backscatter channel.

18. The method of claim 17, further comprising:
transmitting, to the transmitter device, a request for the channel autocorrelation metric; and
receiving the channel autocorrelation metric from the transmitter device in response to the request.

19. The method of claim 17, wherein the modulation phase is further determined based at least in part on the emitter signal comprising a constant-energy signal.

20. A non-transitory computer-readable medium storing code, the code comprising instructions executable by one or more processors to:
receive, over a backscatter channel, one or more synchronization signals from a transmitter device via a backscatter-capable device, wherein the one or more synchronization signals are associated with a subcarrier allocation configuration comprising a set of occupied subcarriers interleaved with a set of unoccupied subcarriers;
receive a backscattered signal from the backscatter-capable device via the backscatter channel, the backscattered signal based at least in part on an emitter signal from the transmitter device and a data payload from the backscatter-capable device;
determine a modulation phase of the backscattered signal based at least in part on a comparison between at least a first subcarrier and a second subcarrier of the backscattered signal, wherein the first subcarrier and the second subcarrier are determined relative to at least one occupied subcarrier of the set of occupied subcarriers based at least in part on the subcarrier allocation configuration; and
decode the data payload from the backscattered signal based at least in part on a phase shift of the backscattered signal, wherein the phase shift is determined based at least in part on the modulation phase.
